(19) United States
(12) Patent Application Publication
(10) Pub. No.: US 2025/0144848 A1
(43) Pub. Date: May 8, 2025

(54) MOLD DEVICE AND FOAM PRODUCTION METHOD

(71) Applicant: INOAC CORPORATION, Nagoya-shi, Aichi (JP)

(72) Inventors: Hiroshi SUZUKI, Anjo-shi, Aichi (JP); Osamu ITO, Anjo-shi, Aichi (JP); Shanchuu YU, Anjo-shi, Aichi (JP)

(73) Assignee: INOAC CORPORATION, Nagoya-shi, Aichi (JP)

(21) Appl. No.: 18/838,250

(22) PCT Filed: Feb. 22, 2023
(86) PCT No.: PCT/JP2023/006353

§ 371 Date: Aug. 14, 2024

(30) Foreign Application Priority Data
Feb. 24, 2022 (JP) 2022-026343
Mar. 2, 2022 (JP) 2022-031594
Jun. 2, 2022 (JP) 2022-090442

(51) Int. Cl. B29C 33/20; B29C 44/58; B29K 105/04

(52) U.S. Cl. CPC B29C 33/202; B29C 44/58; B29C 2033/207; B29K 2105/04

(57) ABSTRACT

A mold device which includes a first mold and a second mold, and in which a cavity is formed by closing the first and second molds, the mold device including a displacement portion that is provided on a first surface of the first mold and is displaced, along the first surface and in a first direction that is a direction along the first surface, between a press position and a release position, the displacement portion pressing the second mold against the first mold when positioned in the press position and releasing the pressing when positioned in the release position.

### TECHNICAL FIELD

The present disclosure relates to a mold device, and a foam production method in which the mold device is used.

### BACKGROUND ART

Conventionally, foam-molding mold devices including an upper mold and a lower mold that are separated in the top-bottom direction are known. Such a foam-molding mold produces a foam by foaming a foam raw material inside a cavity that is formed in a state in which the upper and lower molds are closed.

In such a mold device, end portions of the upper and lower molds are clamped together by a clamp mechanism (for example, see Patent Literature 1). By clamping together the upper and lower molds in such a manner, gaps around the cavity are closed off, and a situation is prevented in which the foam raw material flows out to the vicinity of the cavity and burrs occur on the foam.

### CITATION LIST

### Patent Literature

[Patent Literature 1] Japanese Examined Utility Model Application Publication No. H3-15286

### SUMMARY OF INVENTION

### Technical Problem

In such a mold device, the clamp mechanism switches between a press position in which the upper mold is pressed against the lower mold and a release position in which the pressing is released. The mold device is opened when the clamp mechanism is in the release position. In doing so, it is preferable that the mold device be capable of being opened smoothly without interference between the clamp mechanism and other devices. A problem addressed by the present disclosure is to provide a mold device that can be opened smoothly in a smaller space, and a foam production method in which the mold device is used.

### Solution to Problem

A mold device according to the present disclosure is a mold device which includes a first mold and a second mold, and in which a cavity is formed by closing the first and second molds, the mold device including a displacement portion that is disposed on a first-surface side of the first mold and is displaced, along the first surface and in a first direction that is a direction along the first surface, between a press position and a release position, the displacement portion pressing the second mold against the first mold when positioned in the press position and releasing the pressing when positioned in the release position.

This mold device can be opened smoothly in a smaller space because the displacement portion is displaced in the first direction along the first surface.

Furthermore, a mold device according to another aspect of the present disclosure is a mold device which includes the first mold and the second mold, and in which the cavity is formed by closing the first and second molds. The mold device includes a first displacement portion and a second displacement portion. The first displacement portion is provided on the first surface of the first mold, and is displaced in the first direction between a first press position and a first release position. The first displacement portion presses the second mold against the first mold when positioned in the first press position and releases the pressing when positioned in the first release position. The second displacement portion is provided on a second surface that intersects the first surface, and is displaced, along the same direction as the first direction, between a second press position and a second release position. The second displacement portion presses the second mold against the first mold when positioned in the second press position and releases the pressing when positioned in the second release position.

According to this mold device, the first displacement portion provided on the first surface and the second displacement portion provided on the second surface intersecting the first surface are displaced along the same direction. Thus, the space required for the movement of the first displacement portion and the second displacement portion when the second mold is pressed against the first mold can be reduced. Due to this, the mold device can mold a foam in a smaller space without interference with other devices. Accordingly, this mold device can be opened smoothly in a smaller space.

Furthermore, a mold device according to another aspect of the present disclosure includes a hinge member and a third displacement portion. The hinge member includes a shaft member extending in a second direction intersecting the first direction, and supports the first and second molds so as to be rotatable about the shaft member. The third displacement portion is displaced between a third press position and a third release position, and presses the shaft member in a third direction intersecting the second direction when positioned in the third press position and releases the pressing when positioned in the third release position.

According to this mold device, a mold device that can prevent the occurrence of burrs on a foam to a further extent can be provided.

Furthermore, in a mold device according to another aspect of the present disclosure, the first mold includes a first surface that extends in the first direction and a second surface that extends in a second direction intersecting the first direction, the second mold includes a third surface that extends in the first direction and a fourth surface that extends in the second direction, and the mold device includes: a first fixed member that is fixed to the fourth surface; and a sixth displacement portion that is rotatably supported by a sixth shaft extending in the second direction, and is displaced between a sixth press position in which the sixth displacement portion presses the first fixed member in a third direction intersecting the first and second directions and a sixth release position in which the sixth displacement portion releases the pressing. The first fixed member includes a receiving portion that projects further in the second direction than the first surface or the third surface, and the sixth displacement portion includes a pressing portion that swings along the first direction between the sixth press position and the sixth release position and that, in the sixth press position, presses the receiving portion.

According to this mold device, the sixth displacement portion swings along the first direction, in which the first surface extends, and presses the receiving portion. Thus, a mold device having a smaller size can be provided.

According to the present disclosure, a mold device that can be opened smoothly in a smaller space, and a foam production method in which the mold device is used can be provided.

### BRIEF DESCRIPTION OF DRAWINGS

FIG. 1 is a side view of a mold device in a first embodiment of the present disclosure.

FIG. 2 is a plan view of the mold device in the first embodiment of the present disclosure.

FIG. 3 is an enlarged view of a second lever according to the first embodiment of the present disclosure.

FIG. 4 is an enlarged view of a first lever according to the first embodiment of the present disclosure.

FIG. 5 is a diagram illustrating a lever ratio in a mold device in a second embodiment of the present disclosure.

FIG. 6 is a diagram illustrating operational states of the mold device in the second embodiment of the present disclosure.

FIG. 7 is a diagram illustrating the operation of the mold device in the second embodiment of the present disclosure.

FIG. 8 is a diagram illustrating the operation of a mold device in another embodiment of the present disclosure.

FIG. 9 is a right side view of a mold device in a third embodiment of the present disclosure.

FIG. 10 is a top view of the mold device in the third embodiment of the present disclosure.

FIG. 11 is a rear view of the mold device in the third embodiment of the present disclosure.

FIG. 12 is a cross-sectional view of the mold device when a third lever is positioned in a third release position.

FIG. 13 is a cross-sectional view of the mold device when the third lever is positioned in a third press position.

FIG. 14 is a right side view of a mold device in a fourth embodiment of the present disclosure.

FIG. 15 is a side view of a mold device in a fifth embodiment of the present disclosure.

FIG. 16 is a top view of the mold device in the fifth embodiment of the present disclosure.

FIG. 17 is a front view of the mold device in the fifth embodiment of the present disclosure.

FIG. 18 is an enlarged view of a sixth-lever portion in the fifth embodiment of the present disclosure.

FIG. 19 is an enlarged view of a seventh-lever portion in the fifth embodiment of the present disclosure.

FIG. 20 is a side view of a mold device in a sixth embodiment of the present disclosure.

FIG. 21 is a front view of the mold device in the sixth embodiment of the present disclosure.

FIG. 22 is an enlarged view of a tenth-lever portion in the sixth embodiment of the present disclosure.

FIG. 23 is a side view of a mold device in another embodiment of the present disclosure.

### DESCRIPTION OF EMBODIMENTS

### First Embodiment

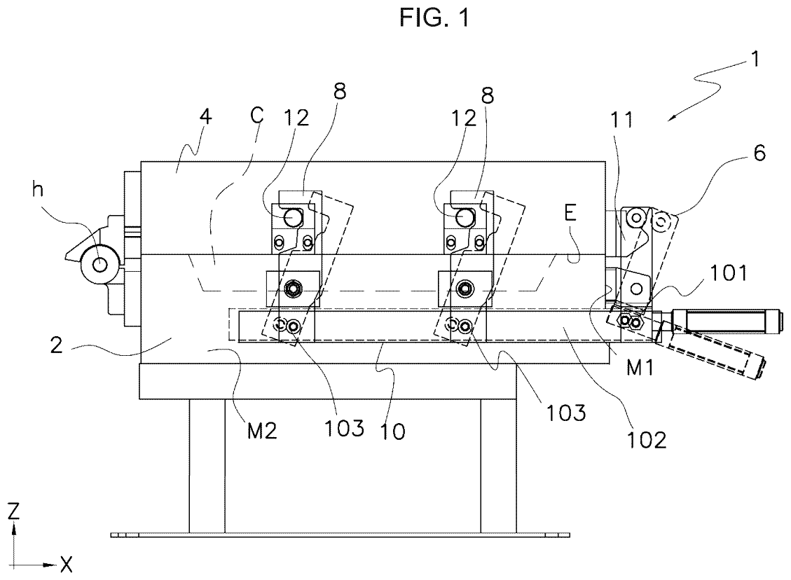

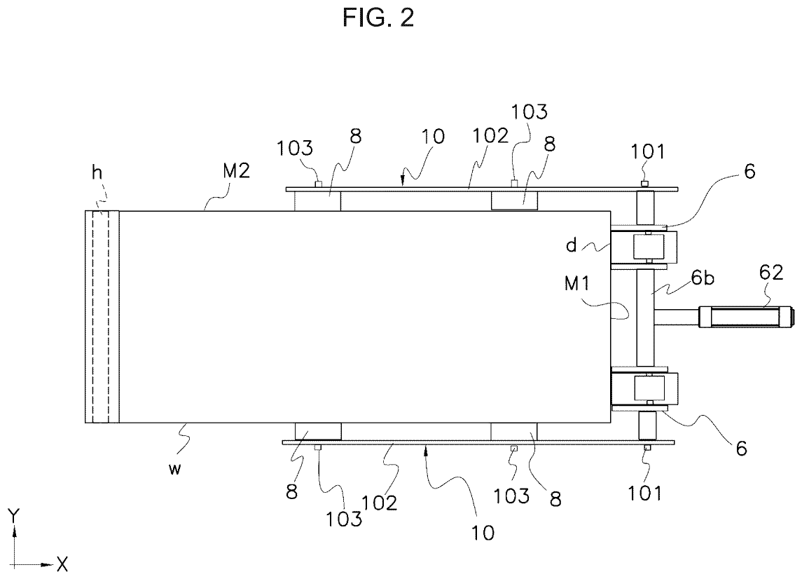

In the following, an embodiment of the present disclosure will be described with reference to the drawings. Note that, hereinafter in the present description, the left-right direction (one example of a second direction; the Y direction in FIG. 2) is the same direction as the width direction of a mold device 1, and the front-rear direction (one example of a first direction; the X direction in FIG. 1) is the same direction as the depth direction of the mold device 1. As illustrated in FIGS. 1 and 2, the mold device 1 includes a lower mold (one example of a first mold) 2 and an upper mold (one example of a second mold) 4, and a cavity C is formed by closing the lower mold 2 and the upper mold 4. The mold device 1 receives a foam raw material in the cavity C, and molds a foam by foaming and hardening the foam raw material inside the cavity C. In the present embodiment, the foam raw material is a foamed-resin raw material that is obtained by mixing solution A that mainly contains a polyol and solution B that mainly contains an isocyanate. For example, the cavity C is formed in a shape adapted to that of a member such as an energy-absorbing member for use in automobiles. However, there is no limitation to this, and various shapes are applicable to the cavity C.

The lower mold 2 and the upper mold 4 are substantially-rectangular-parallelepiped-shaped structures extending in the front-rear direction, the left-right direction, and the top-bottom direction (one example of a third direction; the Z direction in FIG. 1). In the present embodiment, the top-bottom direction substantially coincides with the direction of gravity, and intersects the left-right direction and the front-rear direction. In other words, the left-right direction and the front-rear direction substantially coincide with the horizontal direction. As illustrated in FIG. 2, in a plan view, the lower mold 2 and the upper mold 4 are rectangles having short sides d extending in the left-right direction and long sides w extending in the front-rear direction. The later-described front surface M1 (one example of a second surface) is a surface of the lower mold 2 that includes a short side d and extends in the top-bottom direction and the left-right direction. The later-described side surface M2 (one example of a first surface) is a surface of the lower mold 2 that includes a long side w and extends in the top-bottom direction and the front-rear direction. That is, the front surface M1 and the side surface M2 are two surfaces of the mold device 1 that are adjacent to one another.

In the mold device 1, the lower mold 2 and the upper mold 4 are closed with a parting surface E as the mating surface. The parting surface E extends substantially horizontally. The lower mold 2 and the upper mold 4 open and close in the top-bottom direction via a hinge h that is provided on the opposite side from the front surface M1.

The mold device 1 includes a second lever (one example of a second displacement portion) 6, a first lever (one example of a displacement portion; one example of a first displacement portion) 8, a link mechanism (one example of a linking portion) 10, a second receiving portion 11, and a first receiving portion (receiving member) 12.

As illustrated in FIGS. 1, 2, and 4, the first lever 8 is displaced between a first press position P1 and a first release position L1. As a result of the first lever 8 being positioned in the first press position P1, a pressed state in which the upper mold 4 is pressed against the lower mold 2 is maintained in a long side w of the mold device 1. Specifically, in the first press position P1, the first lever 8 fixes the lower mold 2 and the upper mold 4 to one another by applying a force along the top-bottom direction to the lower mold 2 and the upper mold 4.

As illustrated in FIGS. 1, 2, and 3, when positioned in a second release position L2, the second lever 6 establishes a released state in which the force along the top-bottom direction applied to the lower mold 2 and the upper mold 4 is completely released. Thus, the upper mold 4 is placed in a state in which the upper mold 4 can rotate upward with the hinge h as a fulcrum. In the present embodiment, the second release position L2 is the maximum displacement position of the second lever 6 opposite from a second press position P2.

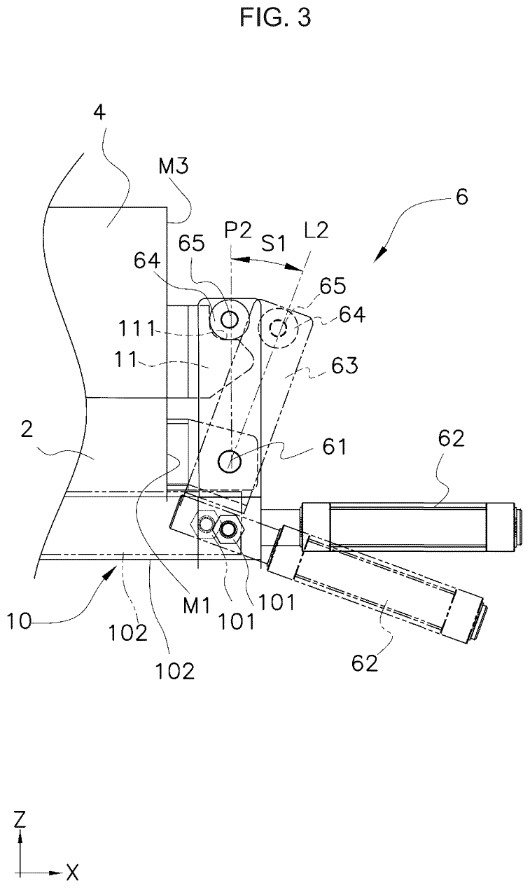

As illustrated in FIG. 3, the second lever 6 is provided on the front surface M1 of the lower mold 2. In the present embodiment, two second levers 6 are provided side by side in the left-right direction on the front surface M1. The second lever 6 includes a second shaft 61, a handle (one example of an operating portion) 62, and a second pressing portion 63. The second shaft 61 extends in the left-right direction along the front surface M1. The handle 62 extends in a direction intersecting the second shaft 61. In the present embodiment, the handle 62 is a rod member extending along the front-rear direction. The handle 62 is fixed to a connection member 6b (see FIG. 2) that connects the two second levers 6 in the left-right direction. The second pressing portion 63 extends in a direction intersecting the second shaft 61. In the present embodiment, the second pressing portion 63 is a plate-shaped member that extends along the top-bottom direction. That is, the second shaft 61, the handle 62, and the second pressing portion 63 extend in mutually intersecting directions. The handle 62 and the second pressing portion 63 are connected via the second shaft 61. When the handle 62 is operated in the top-bottom direction, the second pressing portion 63 rotationally moves about the second shaft 61. Specifically, the second lever 6 swings about the second shaft 61 and is displaced along a first direction S1.

By operating the handle 62 along the top-bottom direction, the second lever 6 in the present embodiment swings between the second press position P2 and the second release position L2 about the second shaft 61. When positioned in the second press position P2, the second lever 6 presses the upper mold 4 against the lower mold 2 via the second pressing portion 63. When positioned in the second release position L2, the second lever 6 completely releases the pressing.

The second pressing portion 63 includes a wheel 64. The wheel 64 is rotatable about a rotation shaft 65 that is substantially parallel with the second shaft 61. On the other hand, the second receiving portion 11 is provided on a third surface M3 of the upper mold 4 that corresponds to the front surface M1 of the lower mold 2. The second receiving portion 11 includes a second receiving surface 111 matching the shape of the wheel 64. The second receiving surface 111 is a curved surface at least part of which is formed to have a radius of curvature corresponding to the diameter of the wheel 64, and which is concave downward in the top-bottom direction.

When the second lever 6 is positioned in the second press position P2, the wheel 64 applies a pressing force downward in the top-bottom direction to the second receiving surface 111 of the second receiving portion 11. Meanwhile, the second receiving surface 111 applies, to the wheel 64, a reaction force that has the same magnitude as the pressing force. This enables the second pressing portion 63 and the second receiving portion 11 to press against one another along the top-bottom direction when the second lever 6 is positioned in the second press position P2. Thus, when positioned in the second press position P2, the second lever 6 can press the upper mold 4 against the lower mold 2 and maintain the pressed state.

In the present embodiment of the present disclosure, the second lever 6 maintains the lower mold 2 and the upper mold 4 in the pressed state as a result of the wheel 64 of the second pressing portion 63 and the second receiving surface 111 of the second receiving portion 11 pressing one another. However, there is no limitation to this, and various methods are applicable as the method of pressing by the second lever 6. For example, the second receiving portion 11 may include a wheel that includes a rotation shaft that is substantially parallel with the second shaft 61. The second lever 6 may include a curved surface matching the shape of the wheel. Such a configuration enables the receiving surface provided to the second lever 6 to ride up onto the wheel provided to the second receiving portion 11 as the second lever 6 moves to the second press position P2. This enables the second lever 6 and the second receiving portion 11 to press one another when the second lever 6 is positioned in the second press position P2. Thus, when the second lever 6 is positioned in the second press position P2, the mold device 1 can be maintained in the pressed state.

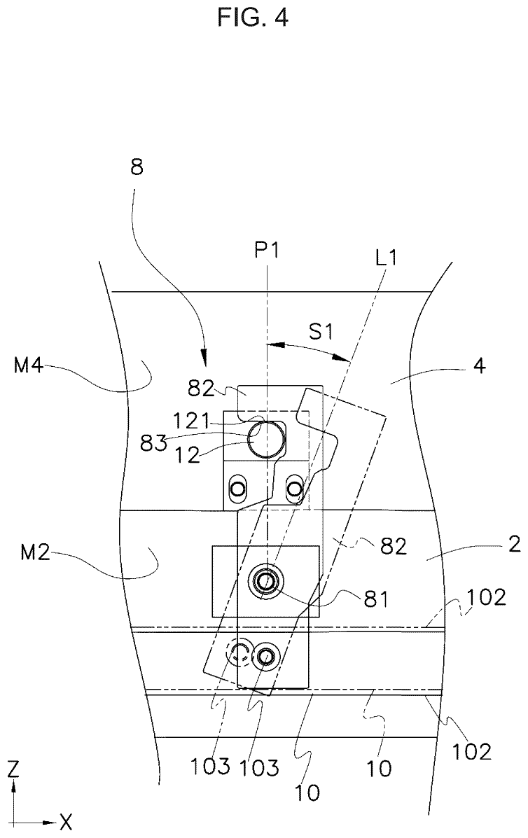

As illustrated in FIGS. 1 and 2, the first lever 8 is provided on the side surface M2 intersecting the front surface M1. In the present embodiment, two first levers 8 are disposed on each side surface M2 in the left-right direction of the mold device 1. Furthermore, while there are two first levers 8 on one side in the left-right direction in the present embodiment, the number of first levers 8 to be disposed can be changed in accordance with the size of the lower mold 2 and the upper mold 4. As illustrated in FIG. 4, the first lever 8 includes a first shaft 81, a first pressing portion 82, and a pressing surface 83. The first shaft 81 is provided so as to project from the side surface M2, and extends substantially in parallel with the second shaft 61 (see FIGS. 1 and 2). The first pressing portion 82 extends in a direction intersecting the first shaft 81.

The first pressing portion 82 is a plate-shaped member that can rotate in the same direction as the second pressing portion 63 (see FIG. 3). The later-described link mechanism 10 is connected to the first pressing portion 82 of the first lever 8. Thus, the first lever 8 is moved rotationally about the first shaft 81 by the link mechanism 10.

In the present embodiment, the first lever 8 swings between the first press position P1 and the first release position L1 about the first shaft 81. The first press position P1 is the position of the first lever 8 when the mold device 1 is in the pressed state. On the other hand, the first release position L1 is the maximum displacement position of the first lever 8 opposite from the first press position P1. When positioned in the first press position P1, the first lever 8 presses the upper mold 4 against the lower mold 2 via the first pressing portion 82. When positioned in the first release position L1, the first lever 8 completely releases the pressing.

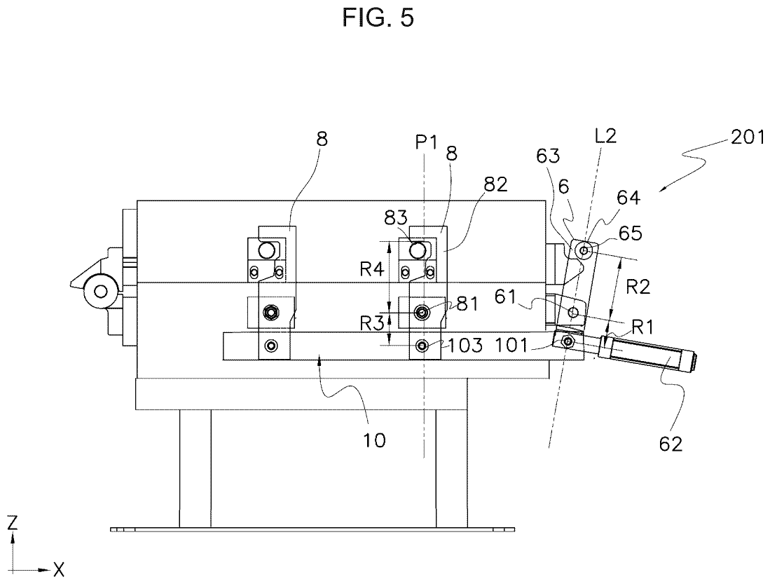

Furthermore, in the mold device 1 in the first embodiment, the distance from the second shaft 61 to the wheel 64 (see R2 in FIG. 5) and the distance from the first shaft 81 to the pressing surface 83 (see R4 in FIG. 5) are equal. Thus, the first pressing portion 82 extends substantially in parallel with the second pressing portion 63 (see FIG. 3), rotates about the first shaft 81, and is displaced along the same direction and with the same radius of rotation as the first direction S1 (see FIG. 3). Specifically, the first lever 8 swings about the first shaft 81, and is displaced, along the same direction and with the same radius of rotation as the first direction S1, between the first press position P1 and the first release position L1.

The pressing surface 83 is formed on the first pressing portion 82. In the present embodiment, the pressing surface 83 is a flat surface that extends substantially horizontally. On the other hand, the first receiving portion 12 is provided on a fourth surface M4 of the upper mold 4 that corresponds to the side surface M2 of the lower mold 2. The first receiving portion 12 includes a first receiving surface (one example of a receiving surface) 121. In the present embodiment, the first receiving surface 121 is a wheel that rotates about a shaft that projects from the fourth surface M4 substantially in parallel with the first shaft 81. Specifically, the first receiving surface 121 is a surface that extends along the first shaft 81 and that matches the shape of the pressing surface 83.

When the first lever 8 is positioned in the first press position P1, the pressing surface 83 of the first pressing portion 82 applies a pressing force downward in the top-bottom direction to the first receiving surface 121 of the first receiving portion 12. Meanwhile, the first receiving surface 121 applies, to the pressing surface 83 of the first pressing portion 82, a reaction force that has the same magnitude as the pressing force. This enables the first pressing portion 82 and the first receiving portion 12 to press against one another along the top-bottom direction when the first lever 8 is positioned in the first press position P1. Thus, when positioned in the first press position P1, the first lever 8 can press the upper mold 4 against the lower mold 2 at least along the closing direction of the lower mold 2 and the upper mold 4 and maintain the pressed state.

In the embodiment of the present disclosure, the first lever 8 maintains the lower mold 2 and the upper mold 4 in the pressed state as a result of the pressing surface 83 of the first pressing portion 82 and the first receiving surface 121 of the first receiving portion 12 pressing one another. However, there is no limitation to this, and various methods are applicable as the method of pressing by the first lever 8. For example, the pressing surface 83 of the first lever 8 may be a wheel that includes a rotating shaft that is substantially parallel with the first shaft 81. On the other hand, the first receiving surface 121 of the first receiving portion 12 may be configured into a curved surface matching the shape of the wheel constituting the pressing surface 83. Such a configuration enables the wheel constituting the pressing surface 83 to ride up onto the first receiving surface 121 of the first receiving portion 12 as the first lever 8 moves to the first press position P1. This enables the first lever 8 and the first receiving portion 12 to press one another when the first lever 8 is positioned in the first press position P1. Thus, when the first lever 8 is positioned in the first press position P1, the mold device 1 can be maintained in the pressed state.

As illustrated in FIGS. 1 and 2, the link mechanism 10 is a synchronous link mechanism that connects and synchronizes the second lever 6 and the first lever 8. In the present embodiment, one link mechanism 10 is disposed along each side surface M2 in the left-right direction of the mold device 1. The link mechanism 10 includes a first link 101, a rod 102, and a second link 103. The link mechanism 10 communicates the movement of the first link 101 provided on the second-lever-6 side to the first lever 8 via the rod 102 and the second link 103. In other words, the link mechanism 10 links the second lever 6 and the first lever 8. Thus, when the second lever 6 is displaced between the second release position L2 (see FIG. 3) and the second press position P2 (see FIG. 3), the first lever 8 is displaced between the first release position L1 (see FIG. 4) and the first press position P1 (see FIG. 4). Conversely, when the first lever 8 is displaced between the first release position L1 and the first press position P1, the second lever 6 is displaced between the second release position L2 and the second press position P2. This enables the upper mold 4 to be pressed against the lower mold 2 in a state in which at least two portions are linked in the mold device 1. Such a configuration enables the upper mold 4 to be pressed against the lower mold 2 simultaneously in at least two positions in the mold device 1 by operation being performed once. Accordingly, the mold device 1 can efficiently produce foams with less burrs.

As illustrated in FIG. 3, the first link 101 connects the second lever 6 and the rod 102. The first link 101 is a rotation shaft that extends substantially in parallel with the second shaft 61. In the present embodiment, the first link 101 connects the two second levers 6. The connection member 6b, to which the handle 62 is connected, serves as the rotation shaft of the first link 101. That is, with the second shaft 61 being between opposed end portions of the second pressing portion 63, the wheel 64 is disposed near one end portion of the second pressing portion 63 of the second lever 6, and the handle 62 and the first link 101 are disposed near the other end portion of the second pressing portion 63 of the second lever 6.

Thus, when the handle 62 of the second lever 6 is operated downward in the top-bottom direction, the second pressing portion 63 rotates about the second shaft 61 along the first direction S1 from the second press position P2 toward the second release position L2. Here, the first link 101 moves over an arc centered on the second shaft 61. Specifically, as illustrated by the first link 101 having moved from the solid line to the virtual line in FIG. 3, the first link 101 moves rearward while approaching the lower mold 2 when the handle 62 is operated downward in the top-bottom direction. Furthermore, as the first link 101 moves, the rod 102 moves rearward along the front-rear direction.

On the other hand, when the handle 62 of the second lever 6 is operated toward the upper side in the top-bottom direction, the second pressing portion 63 rotates about the second shaft 61 along the first direction S1 from the second release position L2 toward the second press position P2. Here, the first link 101 moves over the arc centered on the second shaft 61. Specifically, as illustrated by the first link 101 having moved from the virtual line to the solid line in FIG. 3, the first link 101 moves forward while separating from the lower mold 2 along the front-rear direction when the handle 62 is operated toward the upper side in the top-bottom direction. Furthermore, as the first link 101 moves, the rod 102 moves forward along the front-rear direction. In such a manner, the first link 101 moves the rod 102 in the front-rear direction by moving in the front-rear direction as the second lever 6 swings.

As illustrated in FIGS. 1 and 2, the rod 102 is a rod-shaped member extending along the front-rear direction. In the present embodiment, the rod 102 is disposed adjacent to the side surface M2 of the lower mold 2. The first link 101 is disposed on one side of the rod 102. The second link 103 is disposed on the other side of the rod 102. Thus, the rod 102 moves substantially along the front-rear direction as the second lever 6 swings. In the present embodiment, because there are two first levers 8 on one side in the left-right direction, there are also two second links 103 on one side in the left-right direction.

In the top-bottom direction, the rod 102 is disposed between the parting surface E and the lower end of the lower mold 2. In the present embodiment, the rod 102 is positioned between the parting surface E and the lower end of the lower mold 2 in the top-bottom direction, regardless of whether the mold device 1 is in the pressed state or the released state. That is, in a side view, the rod 102 moves within the area of the side surface M2 of the lower mold 2. Thus, in the top-bottom direction, the rod 102 always moves without protruding from the lower end of the mold device 1. This enables the mold device 1 to be configured to have a small size.

The second link 103 connects the rod 102 and the first lever 8. The second link 103 is a rotation shaft that extends substantially in parallel with the first shaft 81. Specifically, the second shaft 61, the first link 101, the first shaft 81, and the second link 103 are disposed so as to extend substantially along the left-right direction and so as to be substantially in parallel with one another. As illustrated in FIG. 4, in the top-bottom direction, the second link 103 is disposed on the opposite side of the first shaft 81 from the pressing surface 83 of the first pressing portion 82. Thus, when the rod 102 moves, the first lever 8 rotates about the first shaft 81 in the same direction as the first direction S1. This enables the rod 102 to communicate the movement of the second lever 6 to the first lever 8. Thus, the second lever 6 and the first lever 8 can be moved in a linked state by operating the handle 62 of the second lever 6.

### Second Embodiment

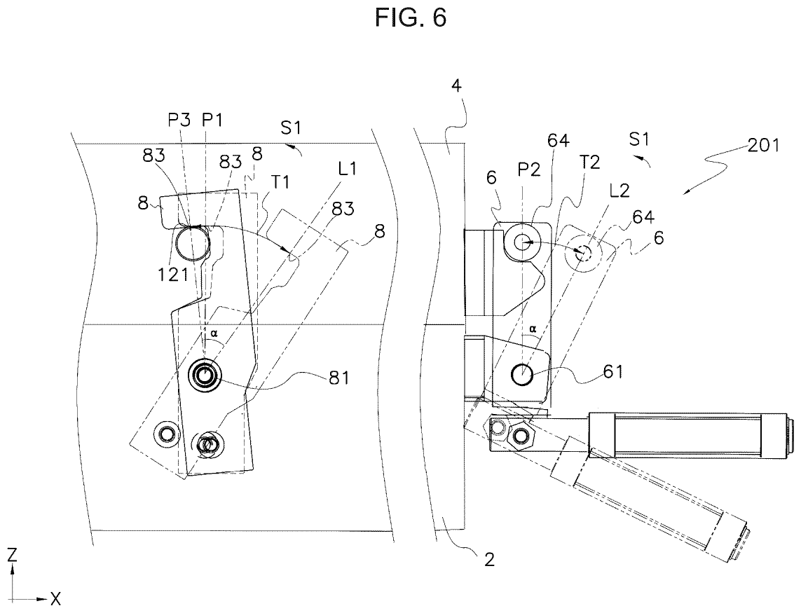

A second embodiment of the present disclosure will be described with reference to FIGS. 5 and 6. In the second embodiment, only a difference from the first embodiment will be described. The difference from the first embodiment is that a mold device 201 in the second embodiment has the later-described lever ratio. This lever ratio adjusts the timings when the second lever 6 and the first lever 8 respectively arrive at the second press position P2 and the first press position P1. Other than the lever ratio, the mold device 201 in the second embodiment has the same component configuration as that in the first embodiment. Thus, the second embodiment will be described using the same reference symbols as those in the component configuration in the first embodiment.

As illustrated in FIG. 5, in the mold device 201 in the second embodiment, the movement distance of the wheel 64 of the second pressing portion 63 relative to the operation amount of the handle 62 of the second lever 6, and the movement distance of the pressing surface 83 of the first lever 8 relative to the operation amount of the handle 62 of the second lever 6 are designed by selecting a lever ratio. The lever ratio is the ratio between a distance R1, a distance R2, a distance R3, and a distance R4. The distance R1 is the distance to the second shaft 61 from the portion where the first link 101 and the second pressing portion 63 are connected. The distance R2 is the distance from the second shaft 61 to the rotation shaft 65 of the wheel 64. The distance R3 is the distance to the first shaft 81 from the portion where the second link 103 and the first pressing portion 82 are connected. The distance R4 is the distance from the first shaft 81 to the pressing surface 83. These distances R1 to R4 determine the movement distance of the wheel 64 of the second pressing portion 63 relative to the operation amount of the handle 62 of the second lever 6, and the movement distance of the pressing surface 83 of the first lever 8 relative to the operation amount of the handle 62 of the second lever 6.

For example, the greater the distance R2 compared to the distance R1, the greater the movement distance of the wheel 64 relative to the operation amount of the handle 62. Conversely, the smaller the distance R2 compared to the distance R1, the smaller the movement distance of the wheel 64 relative to the operation amount of the handle 62.

Also, the movement distance of the pressing surface 83 of the first lever 8 relative to the operation amount of the handle 62 of the second lever 6 can be set based on the ratio between the distances R1, R3, and R4. Furthermore, the movement distance of the wheel 64 of the second lever 6 and the movement distance of the pressing surface 83 of the first lever 8 relative to the operation amount of the handle 62 can be set based on the ratio between the distances R2 and R4.

In the mold device 201, when the link mechanism 10 displaces the second lever 6 from the second release position L2 toward the second press position P2 or the first lever 8 from the first release position L1 toward the first press position P1, one of the second lever 6 and the first lever 8 is displaced to the corresponding one of the second press position P2 and the first press position P1 before the other.

As illustrated in FIG. 6, in the mold device 201 in the present embodiment, when the link mechanism 10 (see FIG. 5) displaces the first lever 8 from the first release position L1 toward the first press position P1, the first lever 8 is displaced to the first press position P1 before the second lever 6 is positioned in the second press position P2.

Specifically, in the present embodiment, the distance R3 and the distance R1 are equal (see FIG. 5), and the distance R4 is longer than the distance R2 (also see FIG. 5). Thus, the distance the pressing surface 83 swings about the first shaft 81 is increased. Specifically, when compared based on the same swing angle α, the swing distance (movement distance) T1 of the pressing surface 83 of the first lever 8 is greater than the swing distance (movement distance) T2 of the wheel 64 of the second lever 6.

This enables the first lever 8 to be displaced to the first press position P1 (see the first lever 8 illustrated using a broken line in FIG. 6) before the second lever 6 is positioned in the second press position P2 when the link mechanism 10 (see FIG. 5) displaces the second lever 6 from the second release position L2 (see the second lever 6 illustrated using a virtual line in FIG. 6) toward the second press position P2 (see the second lever 6 illustrated using a solid line in FIG. 6). In other words, when the second lever 6 is displaced from the second release position L2 toward the second press position P2, the second lever 6 arrives at the second press position P2 after the first lever 8 is positioned in the first press position P1. Furthermore, the first lever 8 is displaced to a final first press position P3 (see the first lever 8 illustrated using a solid line in FIG. 6) as a result of the first lever 8 continuing to be displaced in the same rotation direction (one example of the first direction S1) while maintaining a pressing state in which the first receiving surface 121 is pressed until the second lever 6 arrives at the second press position P2. This enables the first lever 8 to arrive at the first press position P1 earlier and press the side-surface-M2 side (long-side-w side) (see FIG. 1) of the upper mold 4 before the front-surface-M1 side (short-side-d side) (also see FIG. 1) is pressed. Note that such an adjustment can also be made by adjusting the ratio between the distance R1 (see FIG. 5) and the distance R3 (see FIG. 5), and changing the swing angle α. Furthermore, the adjustment can also be made using all of the distances R1 to R4.

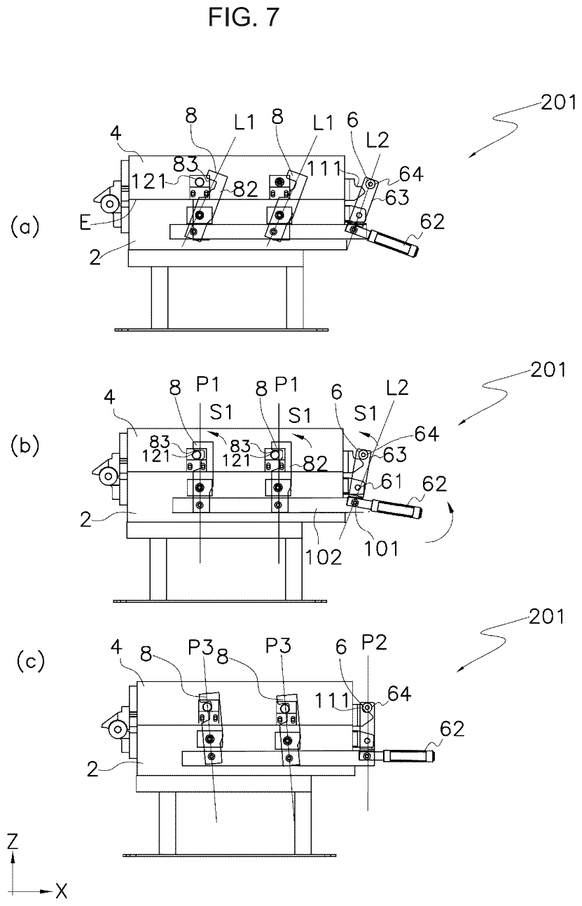

Next, with reference to FIG. 7, a foam production method and the movement of the mold device 201 when the handle 62 is operated will be described. FIG. 7 (a) illustrates the mold device 201 in the released state. FIG. 7 (b) illustrates an intermediate state that is assumed while the mold device 201 transitions from the released state to the pressed state. FIG. 7 (c) illustrates the mold device 201 in the pressed state.

First, in a state in which the upper mold 4 is open, a foam raw material is injected into the cavity C (see FIG. 1). In the present embodiment, solution A that mainly contains a polyol and solution B that mainly contains an isocyanate are injected into the cavity C as the foam raw material. Then, the upper mold 4 and the lower mold 2 are combined. Here, as illustrated in FIG. 7 (a), the second lever 6 is positioned in the second release position L2 when the mold device 201 is in the released state. Furthermore, the first lever 8 is positioned in the first release position L1 when the mold device 201 is in the released state. In the second release position L2, the handle 62 of the second lever 6 is pushed down completely along the top-bottom direction. The wheel 64 of the second pressing portion 63 and the second receiving surface 111 of the second receiving portion 11 are separated from one another substantially along the front-rear direction and are not in contact with one another. Furthermore, the pressing surface 83 of the first pressing portion 82 and the first receiving surface 121 of the first receiving portion 12 are separated from one another substantially along the front-rear direction and are not in contact with one another. Thus, although the lower mold 2 and the upper mold 4 are closed at the parting surface E, the lower mold 2 is merely pressed by the weight of the upper mold 4.

As illustrated in FIG. 7 (b), when the handle 62 of the second lever 6 is pulled up along the top-bottom direction from the released state of the mold device 201, the second lever 6 rotates about the second shaft 61. Here, the wheel 64 of the second pressing portion 63 moves rotationally about the second shaft 61 and approaches the upper mold 4.

Meanwhile, when the handle 62 is pulled up along the top-bottom direction, the rod 102 moves toward the front side in FIG. 7 (b) (toward the handle 62) along the front-rear direction via the first link 101. As the rod 102 moves, the first lever 8 also rotates about the first shaft 81. When the handle 62 is pulled up further along the top-bottom direction, the first lever 8 arrives at the first press position P1 before the second lever 6 arrives at the second press position P2. Here, the second lever 6 has not arrived at the second press position P2 yet.

As illustrated in FIG. 7 (c), as the handle 62 is pulled up further along the top-bottom direction, the wheel 64 comes into contact with the second receiving surface 111 of the second receiving portion 11, and eventually, the second lever 6 arrives at the second press position P2 and the first lever 8 also arrives at the final first press position P3 while maintaining the pressing state. In this state, the foam raw material received in the cavity C (see FIG. 1) is foamed and hardened. Then, the second lever 6 and the first lever 8 are returned to the respective release positions to take out the molded foam. The foam produced in such a manner has less burrs and also has an accurate shape.

According to findings by the present inventors, etc., the upper mold 4 may deform by warping upward in the direction in which the upper mold 4 is longer (either the left-right direction or the front-rear direction) if the second lever 6 and the first lever 8 are moved simultaneously to the respective press positions. If the upper mold 4 warps in such a manner, a gap would be formed around the cavity C (see FIG. 1), and burrs would occur on the foamed molded product. Furthermore, if the second lever 6 is displaced to the second press position P2 before the first lever 8 is displaced to the first press position P1, a space may be formed between the upper mold 4 and the lower mold 2 near where the first lever 8 is arranged, and the handle 62 may need to be operated with a greater force in order to displace the first lever 8 to the first press position P1. The circumstances being such, it would thus be preferable to clamp the mold while suppressing the deformation of the upper mold 4. In the present embodiment, because the front-rear direction corresponds to the long sides w (see FIG. 2), the deformation of the upper mold 4 is suppressed by moving the first lever 8 to the corresponding press position before the second lever 6 does and pressing the center portion of the long side w in advance. This enables the mold device 1 to be placed in the pressed state reliably and with less force. Thus, foams (foamed molded products) having less burrs can be produced.

The first embodiment and the second embodiment of the present disclosure have been described up to this point. However, the present disclosure is not limited to the above-described embodiments, and various modifications are possible without departing from the spirit and scope of the invention. In particular, the modifications disclosed in the present description may be combined as necessary and as appropriate.

For example, in the above-described embodiments, the mold devices 1 and 201 have been described based on an example in which, when the handle 62 of the second lever 6 is operated, the first lever 8 moves in conjunction with the second lever 6 via the link mechanism 10, which moves in the front-rear direction. However, the present disclosure is not limited to this.

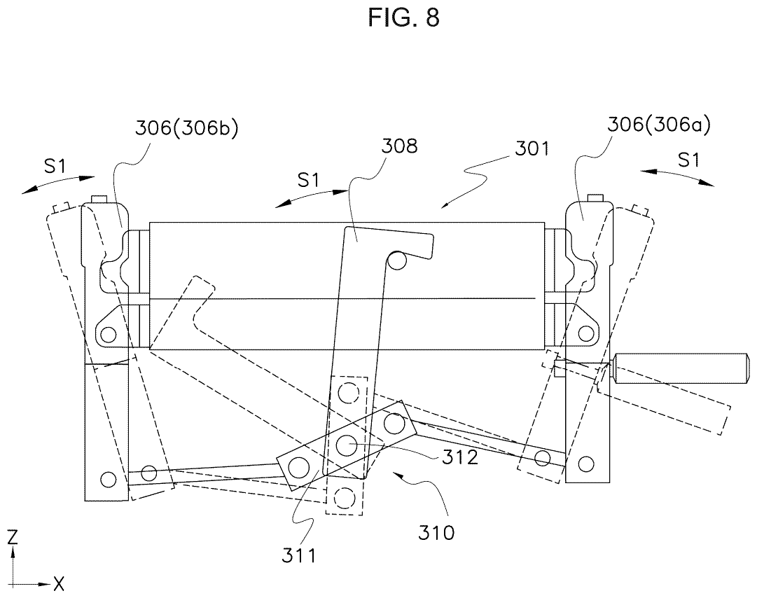

For example, in a mold device 301, a rotary link mechanism 310 that links a second lever 306 and a first lever 308 may be used, as illustrated in FIG. 8. In this case, as the second lever 306 swings, a rotary body 311 of the link mechanism 310 rotates about a rotation shaft 312. The rotation shaft 312 is fixed to the rotary body 311. The first lever 308 is fixed to the rotation shaft 312 and rotates together with the rotation shaft 312. Thus, the first lever 308 swings along the swinging direction (one example of the first direction S1) of the second lever 306 in conjunction with the second lever 306. Note that, in the present embodiment, the front second lever 306a in FIG. 8, and the rear second lever 306b and the first lever 308 in FIG. 8 swing in mutually opposing directions. In such a manner, the present disclosure also includes a mold device 301 in which levers swing along the same direction but move in opposite directions, as is the case with the second lever 306a, and the second lever 306b and the first lever 308.

As described up to this point, according to the present disclosure, the second lever (6, 306) and the first lever (8, 308) are displaced along the first direction S1. Thus, a mold device (1, 201, 301) that can be opened smoothly in a smaller space, and a foam production method in which the mold device (1, 201, 301) is used can be provided.

### Third Embodiment

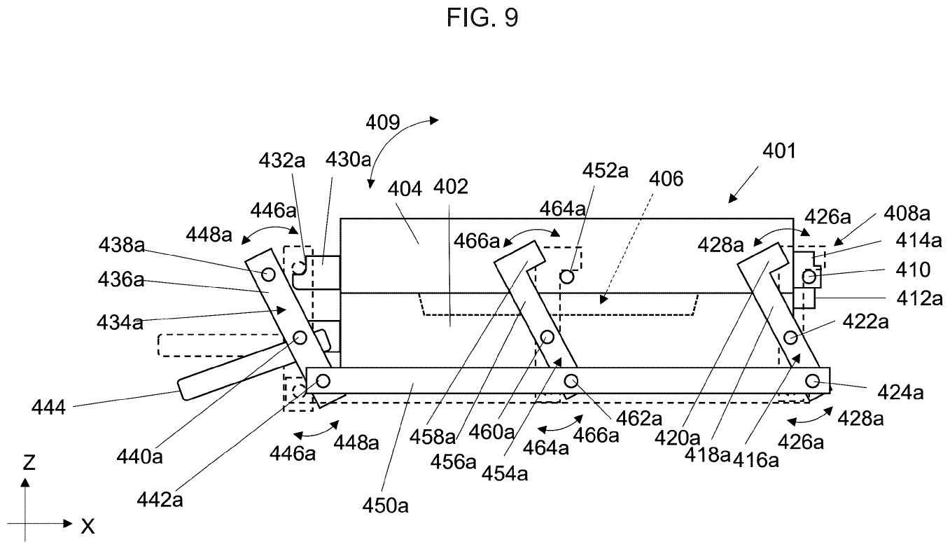

In the following, a third embodiment of the present disclosure will be described with reference to FIGS. 9 to 14. As illustrated in FIGS. 9, 10, and 11, a mold device 401 includes a lower mold (one example of a first mold) 402 and an upper mold (one example of a second mold) 404. In the mold device 401, a cavity 406 is formed by closing the lower mold 402 and the upper mold 404. The mold device 401 is a device in which a foam raw material is injected into the cavity 406, and which molds a foam by foaming and hardening the foam raw material. In the present embodiment, the foam raw material is a foamed-resin raw material that is obtained by mixing solution A that mainly contains a polyol and solution B that mainly contains an isocyanate. For example, the cavity 406 is formed in a shape adapted to that of a member such as an energy-absorbing member for use in automobiles. However, there is no limitation to this, and various shapes are applicable to the cavity 406.

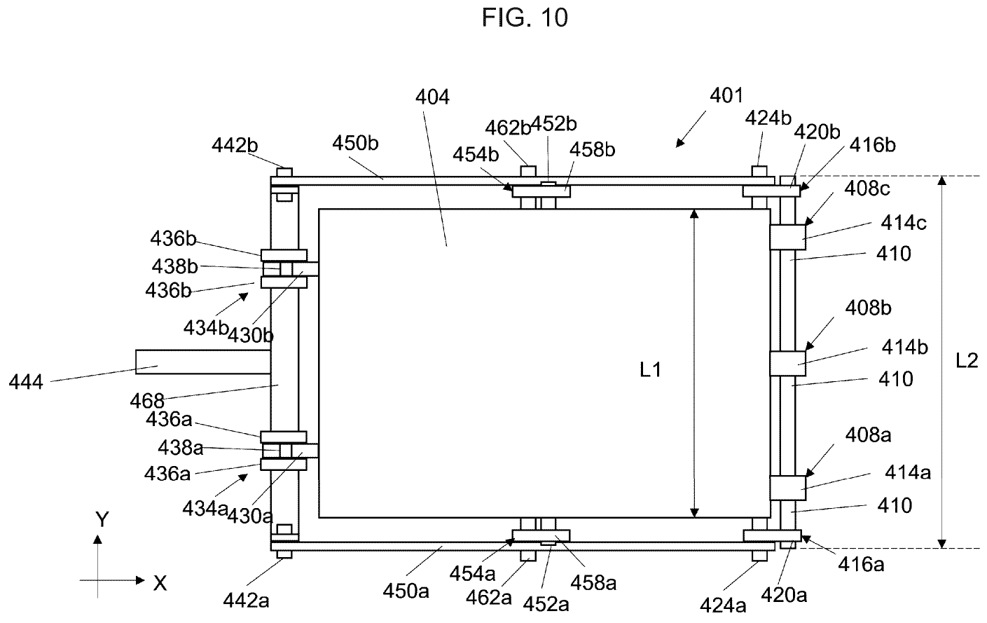

The lower mold 402 and the upper mold 404 are substantially-rectangular-parallelepiped-shaped structures extending in the X direction, the Y direction, and the Z direction. The X direction (one example of a first direction), the Y direction (one example of a second direction), and the Z direction (one example of a third direction) are orthogonal to one another. The lower mold 402 includes a front surface, a rear surface, a right side surface, a left side surface, an upper surface, and a bottom surface. The upper mold 404 also includes a front surface, a rear surface, a right side surface, a left side surface, an upper surface, and a bottom surface. The right side surface of the lower mold 402 and the right side surface of the upper mold 404 are shown in FIG. 9. The upper surface of the upper mold 404 is shown in FIG. 10. The cavity 406 is formed by a recess formed in one or both of the upper surface of the lower mold 402 and the bottom surface of the upper mold 404. The cavity 406 is formed by the upper surface of the lower mold 402 and the bottom surface of the upper mold 404 coming into close contact with one another as a result of the mold being closed.

The mold device 401 includes at least one hinge member that rotatably connects the lower mold 402 and the upper mold 404. In the present embodiment, as illustrated in FIG. 10, the mold device 401 includes hinge members 408a, 408b, and 408c that are arranged in the Y direction.

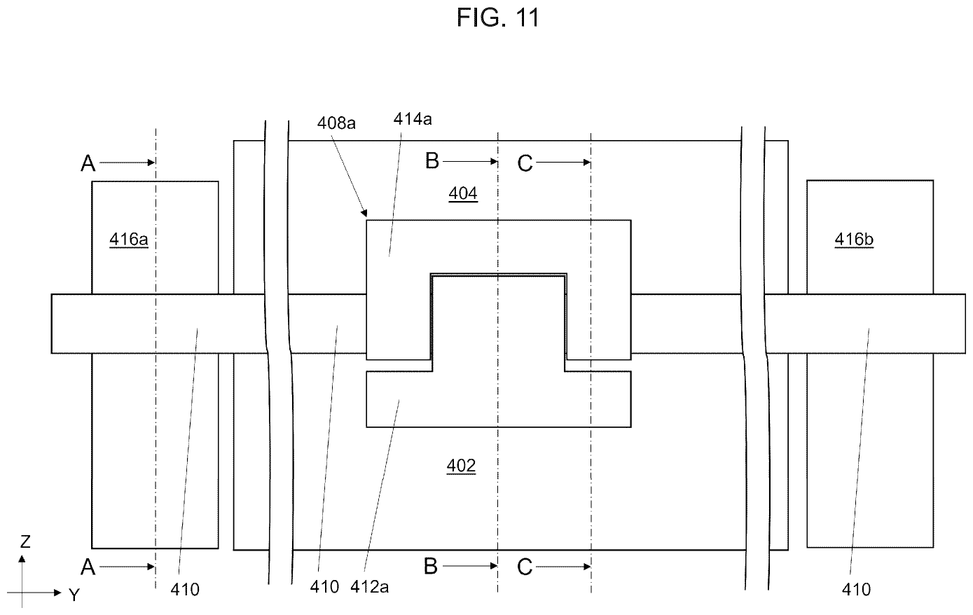

As illustrated in FIGS. 9 and 11, the hinge member 408a includes a shaft member 410, a first member 412a, and a second member 414a. The shaft member 410 extends in the Y direction. The first member 412a is fixed to the lower mold 402, and supports the shaft member 410. Specifically, the first member 412a is fixed to the rear surface of the lower mold 402. The second member 414a is fixed to the upper mold 404, and supports the shaft member 410. Specifically, the second member 414a is fixed to the rear surface of the upper mold 404. The hinge member 408b (see FIG. 10) and the hinge member 408c (also see FIG. 10) also have the same structure as the hinge member 408a. The shaft member 410 is shared by the three hinge members 408a, 408b, and 408c. The upper mold 404 can rotate relative to the lower mold 402 about the shaft member 410 (see arrow 409 in FIG. 9).

The mold device 401 further includes third levers (one example of a displacement portion; one example of a third displacement portion) 416a and 416b. The third lever 416a is provided on the right side surface (one example of a first surface) of the lower mold 402. The third lever 416b is provided on the left side surface of the lower mold 402. As illustrated in FIG. 9, the third lever 416a is displaced between a third press position 426a and a third release position 428a. When positioned in the third press position 426a, the third lever 416a presses the shaft member 410 in the Z direction. When positioned in the third release position 428a, the third lever 416a releases the pressing.

Specifically, the third lever 416a includes a third arm 418a that includes an upper end, a lower end, and an intermediate portion between the upper and lower ends. The lower mold 402 includes a rotation shaft 422a on the right side surface of the lower mold 402. The third lever 416a is rotatably supported by the rotation shaft 422a at the intermediate portion of the third arm 418a. The third lever 416a further includes an engaging portion 420a that is formed at the upper end of the third arm 418a. When the third lever 416a is positioned in the third press position 426a, the engaging portion 420a engages with the shaft member 410 and presses the shaft member 410 in the Z direction. When the third lever 416a is positioned in the third release position 428a, the engaging portion 420a is separated from the shaft member 410. The third lever 416b has the same structure as the third lever 416a. The third lever 416b (see FIG. 11) is displaced between a third press position 426b and a third release position 428b that are not illustrated. When positioned in the third press position 426b, the third lever 416b presses the shaft member 410 in the Z direction. When positioned in the third release position 428b, the third lever 416b releases the pressing.

As illustrated in FIG. 10, the upper mold 404 and the lower mold 402 (see FIG. 9) have a first length L1 in the Y direction. The shaft member 410 has a second length L2 that is greater than the first length L1 in the Y direction. The third lever 416a is provided on the right side surface of the lower mold 402, and can engage with the right end portion of the shaft member 410 by rotating within the XZ plane. The third lever 416b is provided on the left side surface of the lower mold 402, and can engage with the left end portion of the shaft member 410 by rotating within the XZ plane.

As illustrated in FIG. 9, the third lever 416a further includes a rotation shaft 424a that is formed at the lower end of the third arm 418a. The third lever 416a is connected to a linking portion 450a via the rotation shaft 424a. Similarly, as illustrated in FIG. 10, the third lever 416b further includes a rotation shaft 424b that is formed at the lower end of a third arm 418b (not illustrated). The third lever 416b is connected to a linking portion 450b via the rotation shaft 424b.

As illustrated in FIGS. 9 and 10, the mold device 401 further includes fifth levers (one example of a fifth displacement portion) 434a and 434b. The fifth levers 434a and 434b are provided on the front surface of the lower mold 402. The fifth lever 434a is displaced between a fifth press position 446a and a fifth release position 448a. When positioned in the fifth press position 446a, the fifth lever 434a presses the upper mold 404 toward the lower mold 402 in the Z direction. When positioned in the fifth release position 448a, the fifth lever 434a releases the pressing.

Specifically, the fifth lever 434a includes a fifth arm 436a that includes an upper end, a lower end, and an intermediate portion between the upper and lower ends. The lower mold 402 includes a rotation shaft 440a on the front surface of the lower mold 402. The fifth lever 434a is rotatably supported by the rotation shaft 440a at the intermediate portion of the fifth arm 436a. The fifth lever 434a further includes an engaging portion 438a that is formed at the upper end of the fifth arm 436a. On the other hand, the upper mold 404 includes, on the front surface of the upper mold 404, a receiving member 430a that extends in the X direction. The receiving member 430a has a receiving surface 432a that receives the engaging portion 438a. When the fifth lever 434a is positioned in the fifth press position 446a, the engaging portion 438a engages with the receiving member 430a and presses the upper mold 404 toward the lower mold 402 in the Z-axis direction. When the fifth lever 434a is positioned in the fifth release position 448a, the engaging portion 438a is separated from the receiving member 430a.

In the fifth lever 434a, the lower end of the fifth arm 436a is fixed to a connection bar 468. The connection bar 468 is connected to the linking portion 450a via a rotation shaft 442a.

As illustrated in FIG. 10, similarly to the fifth lever 434a, the fifth lever 434b includes a fifth arm 436b and an engaging portion 438b. The lower end of the fifth arm 436b is fixed to the connection bar 468. The upper mold 404 includes, on the front surface of the upper mold 404, a receiving member 430b that extends in the X direction. When the fifth lever 434b is positioned in a fifth press position 446b (see FIG. 9), the engaging portion 438b engages with the receiving member 430b and presses the upper mold 404 toward the lower mold 402 (see FIG. 9) in the Z-axis direction. When the fifth lever 434b is positioned in a fifth release position 448b (see FIG. 9), the engaging portion 438b is separated from the receiving member 430b. The left end of the connection bar 468 is connected to the linking portion 450b via a rotation shaft 442b. The connection bar 468 connects the fifth lever 434a and the fifth lever 434b.

The mold device 401 further includes fourth levers (one example of a fourth displacement portion) 454a and 454b. The fourth lever 454a is provided on the right side surface of the lower mold 402. The fourth lever 454b is provided on the left side surface of the lower mold 402. As illustrated in FIG. 9, the fourth lever 454a is displaced between a fourth press position 464a and a fourth release position 466a. When positioned in the fourth press position 464a, the fourth lever 454a presses the upper mold 404 toward the lower mold 402 in the Z direction. When positioned in the fourth release position 466a, the fourth lever 454a releases the pressing.

Specifically, the fourth lever 454a includes a fourth arm 456a that includes an upper end, a lower end, and an intermediate portion between the upper and lower ends. The lower mold 402 includes a rotation shaft 460a on the right side surface of the lower mold 402. The fourth lever 454a is rotatably supported by the rotation shaft 460a at the intermediate portion of the fourth arm 456a. The fourth lever 454a further includes an engaging portion 458a that is formed at the upper end of the fourth arm 456a. On the other hand, the upper mold 404 includes, on the right side surface of the upper mold 404, a receiving member 452a that extends in the Y direction. When the fourth lever 454a is positioned in the fourth press position 464a, the engaging portion 458a engages with the receiving member 452a and presses the upper mold 404 toward the lower mold 402 in the Z-axis direction. When the fourth lever 454a is positioned in the fourth release position 466a, the engaging portion 458a is separated from the receiving member 452a.

The fourth lever 454a further includes a rotation shaft 462a that is formed at the lower end of the fourth arm 456a. The fourth lever 454a is connected to the linking portion 450a via the rotation shaft 462a.

As illustrated in FIG. 10, similarly to the fourth lever 454a, the fourth lever 454b includes an engaging portion 458b and a rotation shaft 462b. The upper mold 404 includes, on the left side surface of the upper mold 404, a receiving member 452b that extends in the Y direction. When the fourth lever 454b is positioned in a fourth press position 464b (not illustrated), the engaging portion 458b engages with the receiving member 452b and presses the upper mold 404 toward the lower mold 402 (see FIG. 9) in the Z-axis direction. When the fourth lever 454b is positioned in a fourth release position 466b (not illustrated), the engaging portion 458b is separated from the receiving member 452b. The fourth lever 454b is connected to the linking portion 450b via the rotation shaft 462b.

The mold device 401 further includes the above-described linking portions 450a and 450b. The linking portion 450a links the third lever 416a, the fifth lever 434a, and the fourth lever 454a. The linking portion 450b links the third lever 416b, the fifth lever 434b, and the fourth lever 454b.

For example, the linking portion 450a is a bar that extends in the X direction. The linking portion 450a includes a front end, a rear end, and an intermediate portion between the front and rear ends. The linking portion 450a is connected to the connection bar 468 and further connected to the fifth lever 434a via the rotation shaft 442a at the front end, is connected to the fourth lever 454a via the rotation shaft 462a at the intermediate portion, and is connected to the third lever 416a via the rotation shaft 424a at the rear end. The linking portion 450a enables the third lever 416a to move together with the fifth lever 434a and the fourth lever 454a. When the third lever 416a is positioned in the third press position 426a (see FIG. 9), the fifth lever 434a and the fourth lever 454a are respectively positioned in the fifth press position 446a (see FIG. 9) and the fourth press position 464a (also see FIG. 9). When the third lever 416a is positioned in the third release position 428a, the fifth lever 434b and the fourth lever 454b are respectively positioned in the fifth release position 448a and the fourth release position 466a.

Similarly to the link mechanism 10 in the second embodiment, the linking portion 450a may displace the fourth levers 454a and 454b to the fourth press positions 464a and 464b before the third levers 416a and 416b are positioned in the third press positions when the third levers 416a and 416b are displaced from the third release positions toward the third press positions. Alternatively, the linking portion 450a may displace the fourth levers 454a and 454b to the fourth press positions 464a and 464b before the third levers 416a and 416b are positioned in the third press positions when the fourth levers 454a and 454b are displaced from the fourth release positions 466a and 466b toward the fourth press positions 464a and 464b. That is, the third levers 416a and 416b and the fourth levers 454a and 454b may be provided with different lever ratios. Similarly, the linking portion 450a may displace the fourth levers 454a and 454b to the fourth press positions 464a and 464b before the fifth levers 434a and 434b are positioned in the fifth press positions when the fifth levers 434a and 434b are displaced from the fifth release positions toward the fifth press positions. Alternatively, the linking portion 450a may displace the fourth levers 454a and 454b to the fourth press positions 464a and 464b before the fifth levers 434a and 434b are positioned in the fifth press positions when the fourth levers 454a and 454b are displaced from the fourth release positions 466a and 466b toward the fourth press positions 464a and 464b. That is, the fourth levers 454a and 454b and the fifth levers 434a and 434b may be provided with different lever ratios.

The mold device 401 further includes an operation lever 444. The operation lever 444 is connected to the fifth levers 434a and 434b and the linking portions 450a and 450b via the connection bar 468. The operation lever 444 receives, from a person or a machine, a force for moving the third levers 416a and 416b, the fifth levers 434a and 434b, and the fourth levers 454a and 454b.

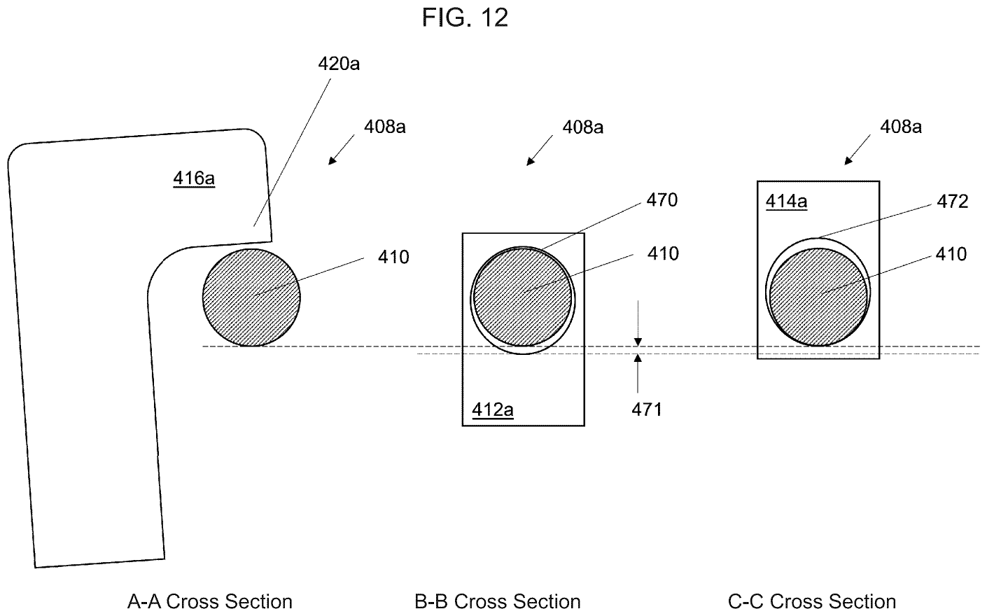

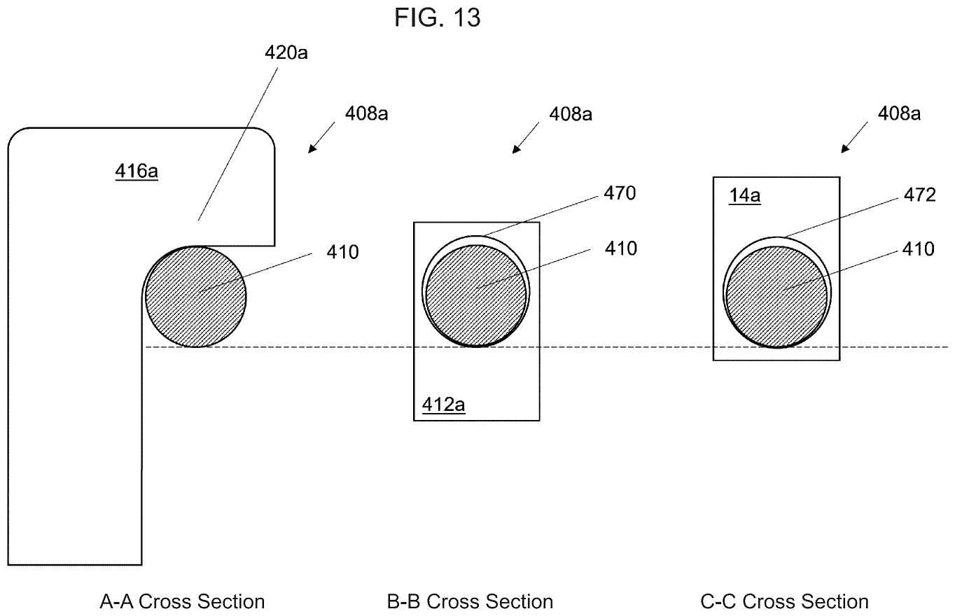

FIG. 12 is a cross-sectional view of the mold device 401 when the third lever 416a is positioned in the third release position 428a (see FIG. 9), and illustrates the A-A, B-B, and C-C cross sections in FIG. 11. FIG. 13 is a cross-sectional view of the mold device 401 when the third lever 416b is positioned in the third press position 426a (see FIG. 9), and illustrates the A-A, B-B, and C-C cross sections in FIG. 11. As described above, the hinge member 408a includes the shaft member 410, the first member 412a, and the second member 414a. As illustrated in FIGS. 12 and 13, the first member 412a includes a first insertion hole 470 for inserting the shaft member 410 through the first member 412a. The second member 414a includes a second insertion hole 472 for inserting the shaft member 410 through the second member 414a.

As illustrated in FIG. 12, when the third lever 416a is positioned in the third release position 428a (see FIG. 9), the third lever 416a is not in contact with the shaft member 410. Here, the lower end of the first insertion hole 470 is positioned lower in the Z direction than the lower end of the second insertion hole 472 by a distance 471. For example, the diameter of the first insertion hole 470 may be greater than the diameter of the second insertion hole 472. Alternatively, the diameter of the first insertion hole 470 may be the same as the diameter of the second insertion hole 472, and the central axis of the first insertion hole 470 may be located lower in the Z direction than the central axis of the second insertion hole 472.

As illustrated in FIG. 13, when the third lever 416a is positioned in the third press position 426a (see FIG. 9), the third lever 416a presses the shaft member 410 downward in the Z direction. Thus, the second member 414a is pressed toward the first member 412a. In other words, the upper mold 404 is pressed toward the lower mold 402.

As described above, the mold device 401 includes the fifth levers 434a and 434b (see FIGS. 9 and 10), which press the upper mold 404 toward the lower mold 402 at the front end of the upper mold 404. When the fifth levers 434a and 434b press the upper mold 404 toward the lower mold 402 at the front end of the upper mold 404, a force lifting the upper mold 404 from the lower mold 402 is produced at the rear end of the upper mold 404 as a counteraction thereto. In the present embodiment, because the third levers 416a and 416b press the upper mold 404 toward the lower mold 402 via the shaft member 410, the upper mold 404 is prevented from being lifted from the lower mold 402 at the rear end of the upper mold 404. Thus, the formation of a gap between the upper mold 404 and the lower mold 402 around the cavity is prevented, and the occurrence of burrs on a foam can be prevented.

Furthermore, the fifth levers 434a and 434b press the upper mold 404 toward the lower mold 402 at the front end of the upper mold 404, and the third levers 416a and 416b press the upper mold 404 toward the lower mold 402 at the rear end of the upper mold 404. Here, a force lifting the upper mold 404 from the lower mold 402 is produced at the center portion of the upper mold 404 as a counteraction thereto. In the present embodiment, because the fourth levers 454a and 454b press the upper mold 404 toward the lower mold 402 at the center portion of the upper mold 404, the upper mold 404 is prevented from being lifted from the lower mold 402 at the center portion of the upper mold 404. Thus, the formation of a gap between the upper mold 404 and the lower mold 402 around the cavity is further prevented, and the occurrence of burrs on a foam can be further prevented.

### Fourth Embodiment

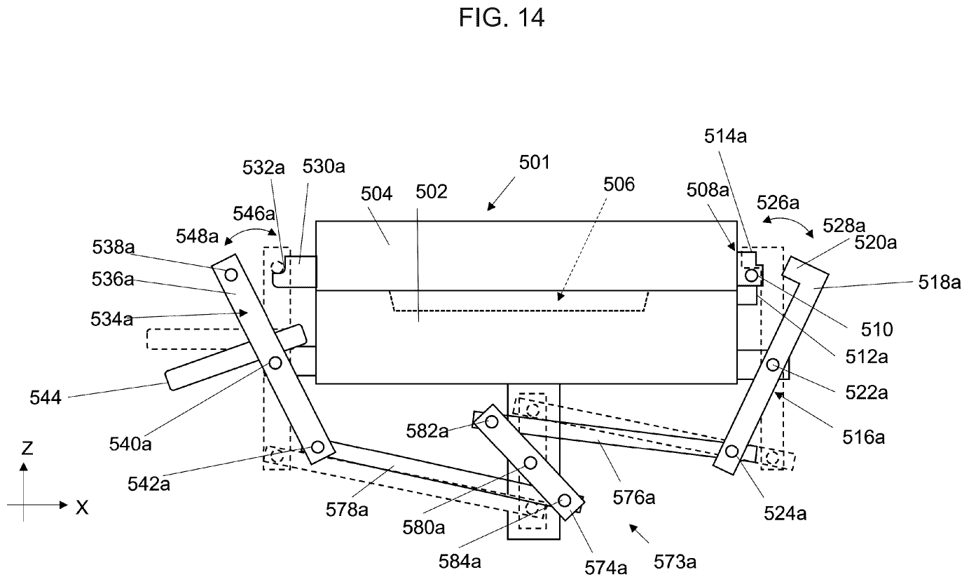

In the following, a fourth embodiment of the present disclosure will be described with reference to FIG. 14. In the third embodiment, the movement direction (rotation direction) of the third levers 416a and 416b is the same as the movement direction (rotation direction) of the fifth levers 434a and 434b. In the fourth embodiment, the movement direction (rotation direction) of a third lever 516a and a third lever 516b (not illustrated) is opposite to the movement direction (rotation direction) of a fifth lever 534a and a fifth lever 534b (not illustrated).

As illustrated in FIG. 14, a mold device 501 includes a linking portion 573a. The linking portion 573a includes a first bar 574a, a second bar 576a, and a third bar 578a. The first bar 574a includes an upper end, a lower end, and an intermediate portion between the upper and lower ends. The intermediate portion is rotatably supported by a lower mold 502 via a rotation shaft 580a. The second bar 576a includes a front end and a rear end. The front end of the second bar 576a is connected to the upper end of the first bar 574a via a rotation shaft 582a. The rear end of the second bar 576a is connected to the lower end of the third lever 516a via a rotation shaft 524a. The third bar 578a includes a front end and a rear end. The front end of the third bar 578a is connected to the lower end of the fifth lever 534a via a rotation shaft 542a. The rear end of the third bar 578a is connected to the lower end of the first bar 574a via a rotation shaft 584a.

In response to the movement of an operation lever 544, the fifth lever 534a is displaced between a fifth press position 546a and a fifth release position 548a. When the fifth lever 534a moves from the fifth release position 548a toward the fifth press position 546a, the fifth lever 534a rotates the first bar 574a clockwise via the third bar 578a. In response to this, the first bar 574a moves the third lever 516a from a third release position 528a toward a third press position 526a via the second bar 576a.

As is the case in the third embodiment, the third levers 516a and 516b may be provided on the right side surface and the left side surface of the lower mold 502.

Next, a foam production method will be described. Foams are produced using the above-described mold devices 401 and 501. In the following description, a method for producing a foam in the mold device 401 in the third embodiment will be described. The method for producing a foam in the mold device 501 in the fourth embodiment is similar to that with the mold device 401 in the third embodiment.

As illustrated in FIGS. 9 and 10, the mold device 401 includes the cavity 406 as described above. First, a foam raw material is introduced into the cavity 406 of the mold device 401.

Next, the upper mold 404 is closed toward the lower mold 402.

Next, the third levers 416a and 416b are respectively set in the third press positions 426a and 426b. For example, the fifth levers 434a and 434b are set in the fifth press positions 446a and 446b by a person or a machine moving the operation lever 444. Then, due to the function of the linking portions 450a and 450b, the fourth levers 454a and 454b are also respectively set in the fourth press positions 464a and 464b. Furthermore, due to the function of the linking portions 450a and 450b, the third levers 416a and 416b are set in the third press positions 426a and 426b.

The foam raw material is foamed and hardened inside the cavity 406, and becomes a molded foam.

Next, the third levers 416a and 416b are respectively set in the third release positions 428a and 428b. For example, the fifth levers 434a and 434b are respectively set in the fifth release positions 448a and 448b by a person or a machine moving the operation lever 444. Then, due to the function of the linking portions 450a and 450b, the fourth levers 454a and 454b are also respectively set in the fourth release positions 466a and 466b. Furthermore, due to the function of the linking portions 450a and 450b, the third levers 416a and 416b are set in the third release positions 428a and 428b.

Next, the upper mold 404 is opened from the lower mold 402. The molded foam is removed from the cavity 406.

As described above, according to the third embodiment and the fourth embodiment of the present disclosure, mold devices 401 and 501 that prevent the occurrence of burrs on foams can be provided.

Note that, while the second member 414a includes the second insertion hole 472 (see FIG. 12) for inserting the shaft member 410 through the second member 414a in the above-described embodiments, the present disclosure is not limited to this. Any configuration suffices as long as the second member 414a supports the shaft member 410, and the second member 414a may be formed integrally with the shaft member 410, for example. In this case, it is sufficient that the lower end of the first insertion hole 470 be positioned lower in the Z direction than the lower end of the shaft member 410 by the distance 471, as illustrated in FIG. 12.

While the mold device 401 includes the three hinge members 408a, 408b, and 408c in the above-described embodiments, the present disclosure is not limited to this. For example, the number of hinge members may be one, two, or four or more.

While the third lever 416a is linked with the fifth lever 434a and the fourth lever 454a via the linking portion 450a in the above-described embodiments, the present disclosure is not limited to this. The third lever 416a may move independently from the fifth lever 434a and the fourth lever 454a.

### Fifth Embodiment

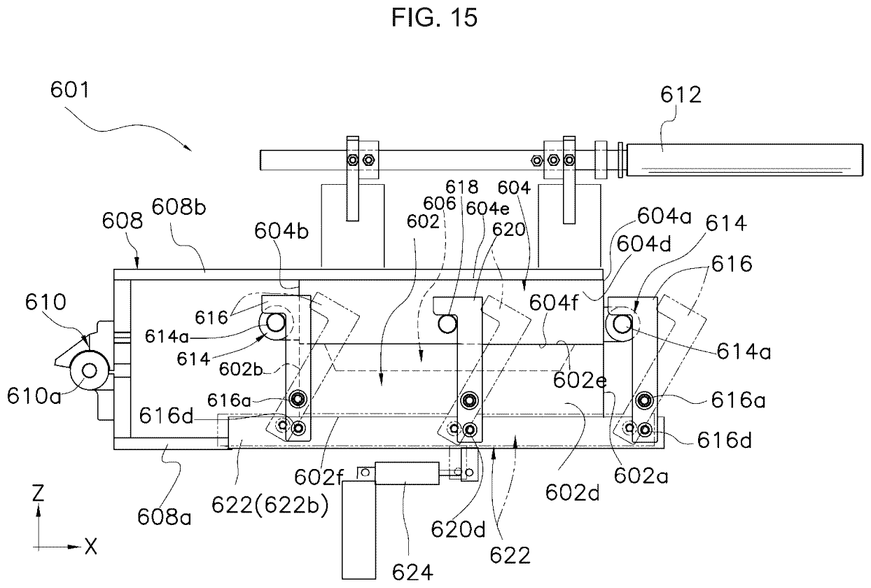

In the following, a fifth embodiment of the present disclosure will be described with reference to the drawings. As illustrated in FIGS. 15, 16, and 17, a mold device 601 includes a lower mold (one example of a first mold) 602 and an upper mold (one example of a second mold) 604. In the mold device 601, a cavity 606 is formed by closing the lower mold 602 and the upper mold 604. The mold device 601 is a device in which a foamed-resin raw material is injected into the cavity 606, and which molds a foamed resin molding (one example of a foamed resin molded product or a foam) by foaming and hardening the foamed-resin raw material. In the present embodiment, the foamed-resin raw material is a foamed-resin raw material that is obtained by mixing solution A that mainly contains a polyol and solution B that mainly contains an isocyanate. For example, the cavity 606 is formed in a shape adapted to that of a member such as an energy-absorbing member for use in automobiles. However, there is no limitation to this, and various shapes are applicable to the cavity 606.

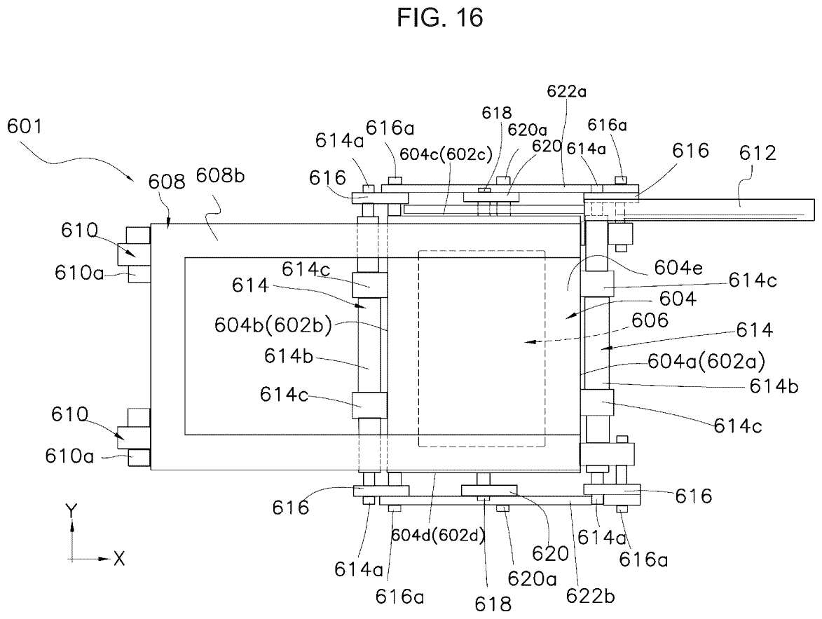

The lower mold 602 and the upper mold 604 are substantially-rectangular-parallelepiped-shaped structures extending in the X direction (one example of a first direction), the Y direction (one example of a second direction), and the Z direction (one example of a third direction). The X direction, the Y direction, and the Z direction are orthogonal to one another. The lower mold 602 includes a lower-mold front surface (one example of a second surface) 602a and a lower-mold rear surface (one example of a second surface) 602b that spread in the Y and Z directions, a lower-mold right side surface (one example of a first surface) 602c and a lower-mold left side surface (one example of a first surface) 602d that spread in the X and Z directions, and (a lower-mold upper surface 602e and) a lower-mold lower surface 602f that spreads in the X and Y directions. Similarly, the upper mold 604 includes an upper-mold front surface (one example of a fourth surface) 604a and an upper-mold rear surface (one example of a fourth surface) 604b that spread in the Y and Z directions, an upper-mold right side surface (one example of a third surface) 604c and an upper-mold left side surface (one example of a third surface) 604d that spread in the X and Z directions, and an upper-mold upper surface 604e (and an upper-mold lower surface 604f) that spreads in the X and Y directions. The lower-mold left side surface 602d and the upper-mold left side surface 604d are shown in FIG. 15. The upper-mold upper surface 604e is shown in FIG. 16. The cavity 606 is formed by a recess formed in one or both of the lower-mold upper surface 602e and the upper-mold lower surface 604f. The cavity 606 is formed by the upper surface of the lower mold 602 and the lower surface of the upper mold 604 coming into close contact with one another as a result of the mold being closed. Note that the directions in which the surfaces of the lower mold 602 and the upper mold 604 spread and extend are not limited to those above. The directions in which the surfaces of the lower mold 602 and the upper mold 604 spread and extend may be changed, as appropriate, in accordance with the shape of the cavity 606, for example.

The mold device 601 includes a frame 608 that supports the lower mold 602 and the upper mold 604. As illustrated in FIGS. 15 and 16, the frame 608 includes a lower frame 608a and an upper frame 608b. The lower frame 608a extends in the X direction along the lower-mold lower surface 602f, and supports the lower mold 602 by being fixed to the lower-mold lower surface 602f. The upper frame 608b extends in the X direction along the upper-mold upper surface 604e, and is fixed to the upper-mold upper surface 604e.

The mold device 601 includes at least one hinge (one example of a hinge member) 610 that rotatably connects the lower mold 602 and the upper mold 604 via the frame 608. The hinge 610 is disposed in a different position from the later-described first fixed member 614. In the present embodiment, the hinge 610 is disposed at the rear end of the frame 608, which is separated in the X direction from the lower-mold rear surface 602b and the upper-mold rear surface 604b. The hinge 610 includes a hinge shaft (one example of a shaft member) 610a. The hinge 610 is disposed in a different position from the first fixed member 614. The hinge 610 supports the lower frame 608a and the upper frame 608b so as to be rotatable about the hinge shaft 610a. Thus, the upper mold 604 rotates in the Z direction relative to the lower mold 602 about the hinge 610.

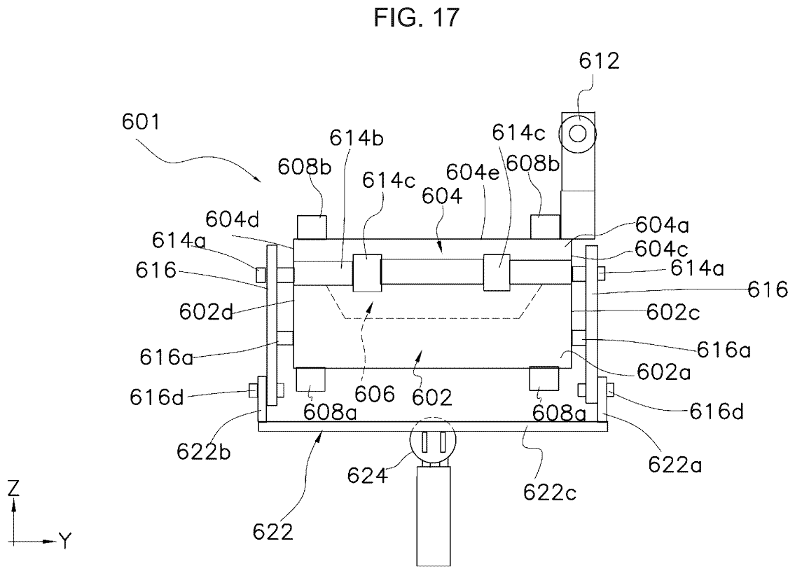

As illustrated in FIG. 16, in the present embodiment, the upper frame 608b is formed from a plurality of metal pipes having rectangular cross-sectional shapes. The upper frame 608b is formed by disposing two pipes extending in the X direction with a space therebetween in the Y direction, and connecting the two pipes using a pipe extending in the Y direction. Two hinges 610 are provided with a space therebetween in the Y direction, and are fixed to the pipe extending in the Y direction. As illustrated in FIG. 17, the lower frame 608a may have a shape similar to that of the upper frame 608b.

Furthermore, as illustrated in FIGS. 15 and 16, the upper frame 608b may include an opening/closing device 612. The opening/closing device 612 may receive a force for moving the upper mold 604 up and down from a person or a machine. A plurality of such mold devices 601 are arranged on a circulating conveyor (circle line) so that the hinge 610 is on the inner-circumferential side of the circle line. The opening/closing device 612 may be configured to operate by receiving a force from a guide rail (one example of a machine) that is provided along the circle line.

The mold device 601 includes at least one first fixed member 614 that receives a force from the later-described sixth lever 616 and presses the upper mold 604 against the lower mold 602. The first fixed member 614 is fixed to at least one of the upper-mold front surface 604a and the upper-mold rear surface 604b. The first fixed member 614 includes receiving portions 614a that project further in the Y direction than the lower-mold right side surface 602c and the lower-mold left side surface 602d, or the upper-mold right side surface 604c and the upper-mold left side surface 604d.

In the present embodiment, one first fixed member 614 is provided on each of the upper-mold front surface 604a and the upper-mold rear surface 604b. The first fixed member 614 is a member that includes a bracket 614c and a cylindrical member 614b made from metal. The cylindrical member 614b is fixed to the upper-mold front surface 604a and the upper-mold rear surface 604b via the bracket 614c. Thus, the first fixed member 614 is fixed to the upper mold 604. The receiving portions 614a are portions that project along the Y direction from this cylindrical member 614b and that have slightly smaller diameter than the cylindrical member 614b.

The mold device 601 includes a sixth lever (one example of a displacement portion; one example of a sixth displacement portion) 616. In the present embodiment, the sixth lever 616 is disposed on both the front-surface side and the rear-surface side of the lower mold 602 and the upper mold 604. Furthermore, the sixth lever 616 is disposed on the left-surface side and the right-surface side of the lower mold 602 and the upper mold 604. Thus, a total of four sixth levers 616 are disposed in the present embodiment. The front-surface-side sixth levers 616 disposed on the left-side-surface and right-side-surface sides and the rear-surface-side sixth levers 616 disposed on the left-side-surface and right-side-surface sides have similar structures and operate in a similar manner. Thus, in the present embodiment, the structure and the operation of the rear-surface-side sixth lever 616 disposed on the left-side-surface side will be described.

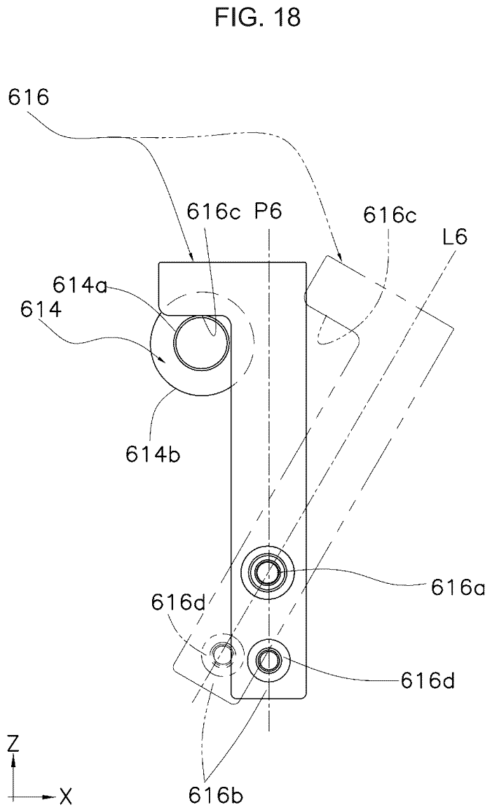

The sixth lever 616 is rotatably supported by one of sixth shafts 616a, which are supported by the lower-mold front surface 602a and the lower-mold rear surface 602b and that extend in the Y direction. As illustrated in FIGS. 15 and 18, the sixth lever 616 is swingingly displaced in the X direction about the sixth shaft 616a. Specifically, as illustrated in FIG. 18, the sixth lever 616 is displaced between a sixth press position P6 and a sixth release position L6. When positioned in the sixth press position P6, the sixth lever 616 presses a receiving portion 614a in the Z direction. When positioned in the sixth release position L6, the sixth lever 616 releases the pressing.

Specifically, the sixth lever 616 includes a sixth arm 616b. The sixth arm 616b includes an upper end, a lower end, and an intermediate portion between the upper and lower ends. The sixth lever 616 is rotatably supported by the sixth shaft 616a at the intermediate portion of the sixth arm 616b. The sixth lever 616 further includes a sixth pressing portion 616c that is formed at the upper end of the sixth arm 616b. When the sixth lever 616 is positioned in the sixth press position P6, the sixth pressing portion 616c engages with the receiving portion 614a and presses the receiving portion 614a in the Z direction. When the sixth lever 616 is positioned in the sixth release position L6, the sixth pressing portion 616c is separated from the receiving portion 614a.

The sixth lever 616 further includes a sixth rotation shaft 616d that is formed at the lower end of the sixth arm 616b. The sixth lever 616 is connected to the later-described linking portion 622 (see FIG. 15) via the sixth rotation shaft 616d.

As illustrated in FIGS. 15 and 16, the mold device 601 includes second fixed members (receiving members) 618. The second fixed members 618 are fixed to the upper-mold right side surface 604c and the upper-mold left side surface 604d of the upper mold 604. In the present embodiment, the second fixed members 618 are cylindrical members that have substantially the same shape as the receiving portions 614a and that project from the upper-mold right side surface 604c and the upper-mold left side surface 604d. The second fixed members 618 are positioned near the center of the length of the upper mold 604 in the X direction. Thus, the first fixed members 614 and the second fixed members 618 can uniformly press the four sides of the upper mold 604 toward the Z direction.

The mold device 601 further includes a seventh lever (one example of a seventh displacement portion in the present embodiment) 620. The seventh lever 620 is disposed between the sixth levers 616 disposed on the front-surface side and the rear-surface side. In the present embodiment, one seventh lever 620 is disposed on both the right side surface and the left side surface of the lower mold 602 and the upper mold 604. The seventh lever 620 disposed on the right side surface and the seventh lever 620 disposed on the left side surface have similar structures and operate in a similar manner. Thus, in the present embodiment, the structure and the operation of the seventh lever 620 disposed on the left side surface will be described.

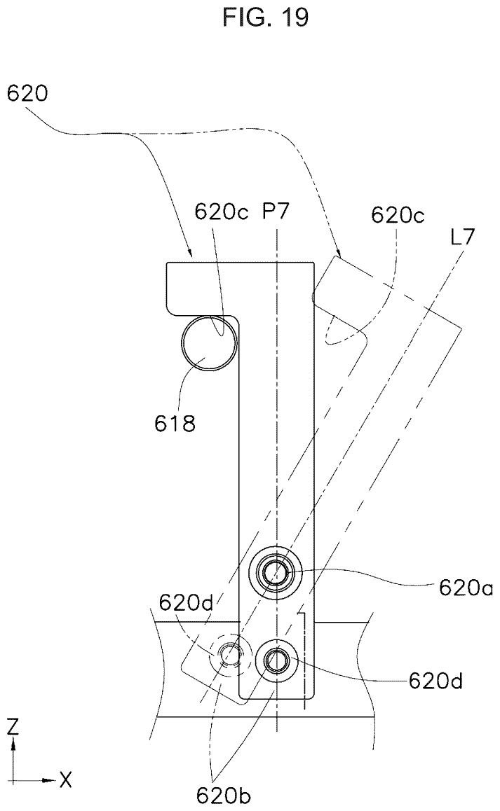

The seventh lever 620 is rotatably supported by a seventh shaft 620a that is supported by one of the lower-mold right side surface 602c and the lower-mold left side surface 602d and that extends in the Y direction. The seventh lever 620 is swingably displaced in the X direction about the seventh shaft 620a. Specifically, as illustrated in FIG. 19, the seventh lever 620 is displaced between a seventh press position P7 and a seventh release position L7. When positioned in the seventh press position P7, the seventh lever 620 presses a second fixed member 618 in the Z direction. When positioned in the seventh release position L7, the seventh lever 620 releases the pressing.

Specifically, the seventh lever 620 includes a seventh arm 620b. The seventh arm 620b includes an upper end, a lower end, and an intermediate portion between the upper and lower ends. The seventh lever 620 is rotatably supported by the seventh shaft 620a at the intermediate portion of the seventh arm 620b. The seventh lever 620 further includes a seventh pressing portion 620c that is formed at the upper end of the seventh arm 620b. When the seventh lever 620 is positioned in the seventh press position P7, the seventh pressing portion 620c engages with the second fixed member 618 and presses the second fixed member 618 in the Z direction. When the seventh lever 620 is positioned in the seventh release position L7, the seventh pressing portion 620c is separated from the second fixed member 618.

The seventh lever 620 further includes a seventh rotation shaft 620d that is formed at the lower end of the seventh arm 620b. The seventh lever 620 is connected to the later-described linking portion 622 (see FIG. 15) via the seventh rotation shaft 620d. Note that, in the present embodiment, the shape of the seventh lever 620 is similar to that of the sixth lever 616. Thus, the production cost of the mold device 601 can be suppressed. Furthermore, the timing when the sixth lever 616 presses the receiving portion 614a and the timing when the seventh lever 620 presses the second fixed member 618 are the same. Thus, the four sides of the upper mold 604 can be pressed simultaneously.

As illustrated in FIGS. 15, 16, and 17, the mold device 601 further includes a linking portion 622. The linking portion 622 links the sixth lever 616 and the seventh lever 620. As illustrated in FIGS. 16 and 17, in the present embodiment, the linking portion 622 includes a right linking bar 622a that extends in the X direction, a left linking bar 622b that extends in the X direction, and a connection bar 622c that connects the right linking bar 622a and the left linking bar 622b. The right linking bar 622a links the sixth lever 616 and the seventh lever 620 that are disposed on the right side surface. The left linking bar 622b links the sixth lever 616 and the seventh lever 620 that are disposed on the left side surface.

The linking portion 622 is connected to the sixth lever 616 via the sixth rotation shaft 616d at each of the front end and the rear end, and is connected to the seventh lever 620 via the seventh rotation shaft 620d at the intermediate portion. The connection bar 622c is connected to the later-described actuator 624. When the actuator 624 moves the connection bar 622c in the X direction, the sixth lever 616 moves to the sixth press position P6 (see FIG. 18), and the seventh lever 620 moves to the seventh press position P7 (see FIG. 19). When the sixth lever 616 is positioned in the sixth release position L6 (see FIG. 18), the seventh lever 620 is positioned in the seventh release position L7 (see FIG. 19).

The mold device 601 further includes an actuator 624 (see FIG. 17). In the present embodiment, the actuator 624 is a pneumatic cylinder. However, the actuator 624 may be that of various types, such as an electric actuator. Furthermore, in the present embodiment, the actuator 624 is a device that moves the connection bar 622c forward and backward along the X direction. However, a device of any type may be adopted, as long as the actuator 624 is capable of operating the linking portion 622.

Next, a method for producing a foamed resin molding will be described. Foamed resin moldings are produced using the above-described mold device 601.

As illustrated in FIGS. 15 and 16, the mold device 1 includes the cavity 606. First, a foamed-resin raw material is introduced into the cavity 606 of the mold device 601.

Next, the upper mold 604 is closed toward the lower mold 602.

Next, the actuator 624 is operated to move the linking portion 622 and set the sixth lever 616 and the seventh lever 620 respectively in the sixth press position P6 (see FIG. 18) and the seventh press position P7 (see FIG. 19). Here, due to the function of the linking portion 622, the sixth lever 616 and the seventh lever 620 move in conjunction. In the present embodiment, the timing when the sixth lever 616 moves to the sixth press position P6 and the timing when the seventh lever 620 moves to the seventh press position P7 are the same.

However, similarly to the link mechanism 10 in the second embodiment, the linking portion 622 may displace the seventh lever 620 to the seventh press position P7 before the sixth lever 616 is positioned in the sixth press position P6 when the sixth lever 616 is displaced from the sixth release position L6 toward the sixth press position P6. Alternatively, the linking portion 622 may displace the seventh lever 620 to the seventh press position P7 before the sixth lever 616 is positioned in the sixth press position P6 when the seventh lever 620 is displaced from the seventh release position L7 toward the seventh press position P7. That is, the sixth lever 616 and the seventh lever 620 may be provided with different lever ratios.

The foamed-resin raw material is foamed and hardened inside the cavity 606, and becomes a molded foamed resin molding.

Next, the sixth lever 616 and the seventh lever 620 are respectively set in the sixth release position L6 (see FIG. 18) and the seventh release position L7 (see FIG. 19).

Next, the upper mold 604 is opened from the lower mold 602, and the molded foamed resin molding is removed from the cavity 606.

According to such a mold device 601, the sixth levers 616 positioned on the rear-surface side swing in the X direction at the Y-direction outer sides of the lower-mold right side surface 602c and the lower-mold left side surface 602d. By swinging in such a manner, the sixth levers 616 can press the rear surface of the upper mold 604 toward the lower mold 602. Thus, in the mold device 601, the size of the area that is necessary on the rear-surface side of the mold device 601 as the space in which the sixth levers 616 swing can be reduced. Because the mold device 601 can be designed with a large size fitting inside the size of the frame 608, the mold device 601 is capable of handling large-sized molded products. Thus, a mold device 601 having a smaller size can be provided.

Furthermore, the seventh levers 620 also swing in the X direction, similarly to the sixth levers 616 on the rear surface and the front surface. Specifically, the seventh levers 620 and the sixth levers 616 on the rear surface and the front surface can press the four sides of the upper mold 4 toward the lower mold 602 while swinging in the same direction. Thus, the size of the Y-direction area of the mold device 1 can be reduced, with there being no lever swinging in the Y direction. Because the mold devices 601 for foamed resin molded products are mounted side by side on a conveyor forming a circle line, the number of mold devices that can be arranged side by side can be increased by reducing the spacing between adjacent mold devices 1. Thus, a method for producing foamed resin molded products in which such a mold device 1 is used enables production efficiency to be improved while suppressing the occurrence of burrs on the foamed resin molded products.

Furthermore, in the present embodiment, the sixth levers 616 on the front-surface side have the same shape as the sixth levers 616 on the rear-surface side. Thus, the production cost of the mold device 601 can be suppressed.

### Sixth Embodiment

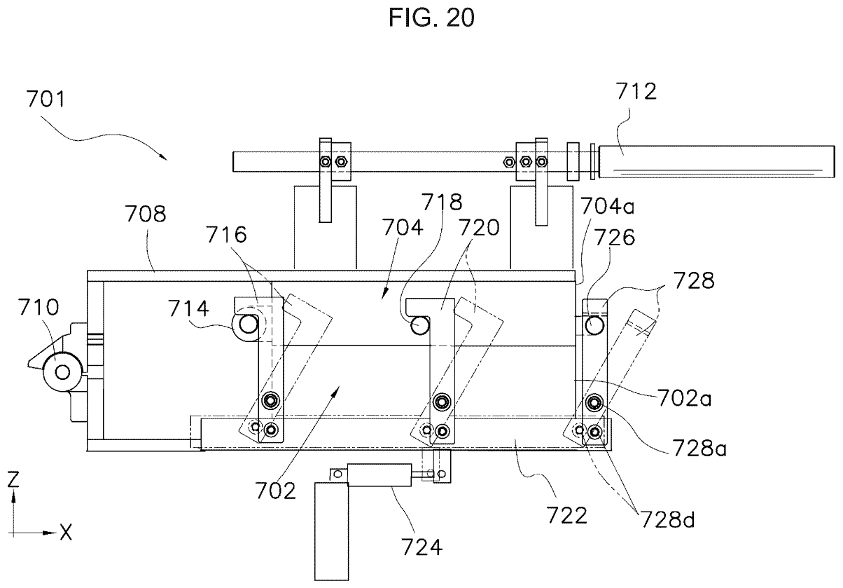

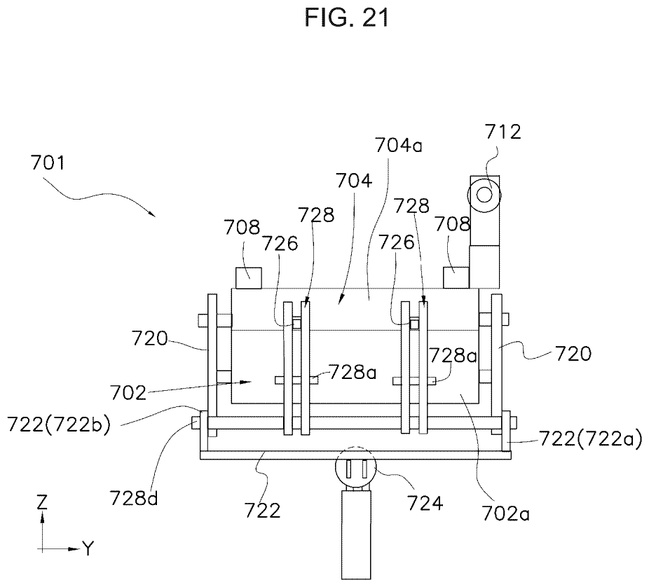

In the following, a sixth embodiment of the present disclosure will be described with reference to FIGS. 20, 21, and 22. In the sixth embodiment, only the difference from the fifth embodiment will be described. As illustrated in FIGS. 20 and 21, in a mold device 701, the structure of a tenth lever 728 on the front surface differs from that of the sixth lever 616 in the fifth embodiment.

As illustrated in FIGS. 20 and 21, the mold device 701 includes a lower mold 702, an upper mold 704, a frame 708, a hinge 710, an opening/closing device 712, a first fixed member 714, an eighth lever 716, a second fixed member (receiving member) 718, a ninth lever 720, a linking portion 722, an actuator 724, a third fixed member 726, and the tenth lever 728. The present embodiment differs from the fifth embodiment in that the first fixed member 614 and the sixth lever 616 located on the front surfaces of the lower mold 602 and the upper mold 604 in the fifth embodiment are replaced with the third fixed member 726 and the tenth lever 728. Thus, because configurations other than the third fixed member 726 and the tenth lever 728 are similar to those in the first embodiment, description thereof will be omitted.

The third fixed member 726 is a cylindrical member that is fixed to an upper-mold front surface 704a of the upper mold 704. As illustrated in FIG. 21, in the present embodiment, two third fixed members 726 are disposed on the upper-mold front surface 704a with a space therebetween in the Y direction.

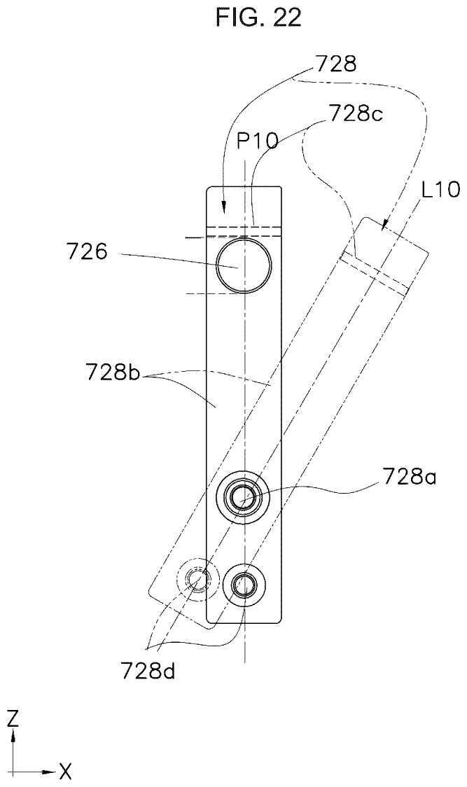

As illustrated in FIGS. 20 and 21, the tenth lever 728 is rotatably supported by a ninth shaft 728a that is fixed to a lower-mold front surface 702a and that extends in the Y direction. In the present embodiment, two tenth levers 728 are disposed with a space therebetween in the Y direction. Similarly to the eighth lever 716, the tenth lever 728 swings in the X direction about the tenth shaft 728a. As illustrated in FIGS. 21 and 22, the tenth lever 728 includes a tenth arm 728b. The tenth arm 728b includes an upper end, a lower end, and an intermediate portion between the upper and lower ends. The tenth arm 728b includes two plate-shaped members and a plate-shaped tenth pressing portion 728c that connects the two plate-shaped members. The tenth lever 728 is rotatably supported by the tenth shaft 728a at the intermediate portion of the tenth arm 728b. When the tenth lever 728 is positioned in a tenth press position P10, the tenth pressing portion 728c engages with the third fixed member 726 and presses the third fixed member 726 in the Z direction. When the tenth lever 728 is positioned in a tenth release position L10, the tenth pressing portion 728c is separated from the third fixed member 726.

The tenth lever 728 further includes a tenth rotation shaft 728d that is formed at the lower end of the tenth arm 728b. In the present embodiment, the tenth rotation shaft 728d is a columnar member that extends from a right linking bar 722a to a left linking bar 722b. The tenth lever 728 is connected to the right linking bar 722a and the left linking bar 722b via the tenth rotation shaft 728d.

In such a manner, even if the sixth lever 616 positioned on the front surfaces of the lower mold 602 and the upper mold 604 in the fifth embodiment is replaced with the tenth lever 728, the eighth lever 716, the ninth lever 720, and the tenth lever 728 swing in the same direction. Thus, in the mold device 701, the four sides of the upper mold 4 can be pressed toward the lower mold 702, with no lever swinging in the Y direction being disposed.

As described up to this point, according to the present disclosure, mold devices 601 and 701 having a smaller size, and methods for producing foamed resin molded products in which the mold devices 601 and 701 are used can be provided.

### Other Embodiments

The fifth embodiment and the sixth embodiment of the present disclosure have been described up to this point. However, the present disclosure is not limited to the above-described embodiments, and various modifications are possible without departing from the spirit and scope of the invention.

For example, in the above-described fifth embodiment, description has been provided based on an example in which two seventh levers 620 are disposed. However, the number of seventh levers 620 may be changed, as appropriate, in accordance with the X-direction length of the lower mold 602 and the upper mold 604.

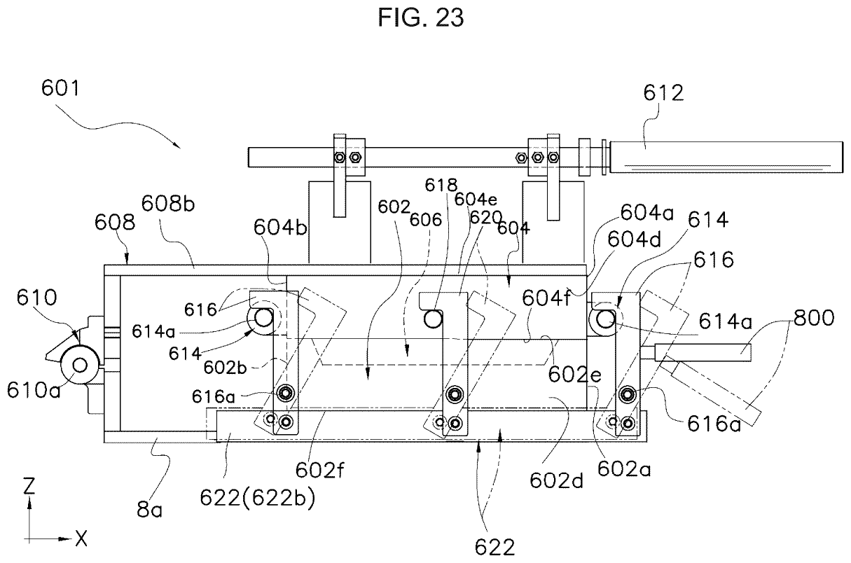

Furthermore, in the above-described fifth embodiment, the sixth lever 616 and the seventh lever 620 are operated by the actuator 624. However, the present disclosure is not limited to this. For example, as illustrated in FIG. 23, the mold device 601 may be configured such that the sixth lever 616 on the front surface is provided with an input bar 800 extending in a direction intersecting the sixth arm 616b, and, similarly to the opening/closing device 612, the input bar 800 is operated by receiving a force from a person or a guide rail provided to a circle line.

### REFERENCE SIGNS LIST

1, 201, 301, 401, 501, 601, 701:2, Mold device
402, 502, 602, 702: Lower mold
4, 404, 604, 704: Upper mold
6, 306: Second lever
6b: Connection member
8, 308: First lever
10, 310: Link mechanism
61: Second shaft
81: First shaft
82: First pressing portion
83: Pressing surface
C: Cavity
L1: First release position
L2: Second release position
M1: Front surface
M2: Side surface
P1: First press position
P2: Second press position
S1: First direction
d: Short side
w: Long side
406: Cavity
408a, 408b, 408c: Hinge member
410: Shaft member
412: First member
414: Second member
416a, 416b: Third lever
426a, 426b: Third press position
428a, 428b: Third release position
454a, 454b: Fourth lever
464a, 464b: Fourth press position
466a, 466b: Fourth release position
434a, 434b: Fifth lever
446a, 446b: Fifth press position
448a, 448a: Fifth release position
450a, 573a: Linking portion
602b: Lower-mold rear surface
602c: Lower-mold right side surface
602d: Left side surface
602d: Lower-mold left side surface
602e: Lower-mold upper surface
602f: Lower-mold lower surface
604a, 204a: Upper-mold front surface
604b: Upper-mold rear surface
604c: Upper-mold right side surface
604d: Upper-mold left side surface
604e: Upper-mold upper surface
6044f: Upper-mold lower surface
606: Cavity
610, 710: Hinge
610a: Hinge shaft
614, 714: First fixed member
614a: Receiving portion
616: Sixth lever
716: Eighth lever
616a: Sixth shaft
616b: Sixth arm
616c: Sixth pressing portion
616d: Sixth rotation shaft
618, 718: Second fixed member
620: Seventh lever
720: Ninth lever
620a: Seventh shaft
620b: Seventh arm
620c: Seventh pressing portion
620d: Seventh rotation shaft
622, 722: Linking portion
624, 724: Actuator
L6: Sixth release position
P6: Sixth press position
L7: Seventh release position
P7: Seventh press position

1. A mold device for foam molding which includes a first mold and a second mold, and in which a cavity is formed by closing the first and second molds, a plurality of the mold devices being disposed side by side on a conveyor, the mold device comprising:
a displacement portion that is disposed on a first-surface side of the first mold and is displaced, along the first surface and in a first direction that is a direction along the first surface, between a press position and a release position, the displacement portion pressing the second mold against the first mold when positioned in the press position and releasing the pressing when positioned in the release position, the first surface facing another one of the mold devices that is adjacent to the mold device.

2. A mold device which includes a first mold and a second mold, and in which a cavity is formed by closing the first and second molds, the mold device comprising:
a first displacement portion that is provided on the first surface of the first mold and is displaced, along the first surface and in the first direction that is a direction along the first surface, between a first press position and a first release position, the first displacement portion pressing the second mold against the first mold when positioned in the first press position and releasing the pressing when positioned in the first release position; and
a second displacement portion that is provided on a second surface intersecting the first surface and is displaced along the same direction as the first direction between a second press position and a second release position, the second displacement portion pressing the second mold against the first mold when positioned in the second press position and releasing the pressing when positioned in the second release position.

3. The mold device according to claim 2 further comprising
a linking portion that links the first displacement portion and the second displacement portion,
wherein, when the first displacement portion is displaced from the first release position toward the first press position or the second displacement portion is displaced from the second release position toward the second press position, one of the first displacement portion and the second displacement portion is displaced to the corresponding one of the first press position or the second press position before the other.

4. The mold device according to claim 3,
wherein the first mold is a rectangle having a short side and a long side in a plan view,
the second surface includes the short side, and the first surface includes the long side, and
when the first displacement portion is displaced from the first release position toward the first press position or the second displacement portion is displaced from the second release position toward the second press position, the first displacement portion is displaced to the first press position before the second displacement portion is positioned in the second press position.

5. A mold device which includes a first mold and a second mold, and in which a cavity is formed by closing the first and second molds, the mold device comprising:
a first displacement portion that is provided on a first surface of the first mold and is displaced, along the first surface and in a first direction that is a direction along the first surface, between a first press position and a first release position, the first displacement portion pressing the second mold against the first mold when positioned in the first press position and releasing the pressing when positioned in the first release position;
a second displacement portion that is provided on a second surface intersecting the first surface and is displaced along the same direction as the first direction between a second press position and a second release position, the second displacement portion pressing the second mold against the first mold when positioned in the second press position and releasing the pressing when positioned in the second release position; and
a linking portion that links the first displacement portion and the second displacement portion,
wherein the first mold is a rectangle having a short side and a long side in a plan view,
the second surface includes the short side, and the first surface includes the long side, and
when the second displacement portion is displaced from the second release position toward the second press position,
the first displacement portion is positioned in the first press position before the second displacement portion is positioned in the second press position, and, until the second displacement portion is positioned in the second press position, the first displacement portion swings in a state in which the pressing is maintained.

6. A mold device which includes a first mold and a second mold, and in which a cavity is formed by closing the first and second molds, the mold device comprising:
a third displacement portion that is disposed on a first-surface side of the first mold; and
a hinge member that includes a shaft member extending in a second direction intersecting a first direction that is a direction along the first surface of the first mold, the hinge member supporting the first and second molds so as to be rotatable about the shaft member,
wherein the third displacement portion is displaced between a third press position and a third release position, and presses the shaft member in a third direction intersecting the first and second directions when positioned in the third press position and releases the pressing when positioned in the third release position.

7. The mold device according to claim 6,
wherein the hinge member includes:
a first member that is fixed to the first mold and that includes a first insertion hole through which the shaft member is inserted; and
a second member that is fixed to the second mold and that supports the shaft member,
wherein, when positioned in the third press position, the third displacement portion presses the shaft member in a direction from the second mold toward the first mold.

8. The mold device according to claim 7,
wherein the second member includes a second insertion hole through which the shaft member is inserted, and
the diameter of the first insertion hole is greater than the diameter of the second insertion hole.

9. The mold device according to claim 6 further comprising
a fourth displacement portion that is provided on the first surface and is displaced in the first direction between a fourth press position and a fourth release position, the fourth displacement portion pressing the second mold against the first mold when positioned in the fourth press position and releasing the pressing when positioned in the fourth release position.

10. The mold device according to claim 9 further comprising
a linking portion that links the third displacement portion and the fourth displacement portion,
wherein, when the third displacement portion is displaced from the third release position toward the third press position or the fourth displacement portion is displaced from the fourth release position toward the fourth press position, the fourth displacement portion is displaced to the fourth press position before the third displacement portion is positioned in the third press position.

11. A mold device which includes a first mold and a second mold, and in which a cavity is formed by closing the first and second molds,
the first mold including a first surface that extends in a first direction and a second surface that extends in a second direction intersecting the first direction, and the second mold including a third surface extending in the first direction and a fourth surface extending in the second direction, the mold device comprising:
a first fixed member that is fixed to the fourth surface; and
a sixth displacement portion that is disposed on the first-surface side and rotatably supported by a sixth shaft extending in the second direction, and is displaced between a sixth press position in which the sixth displacement portion presses the first fixed member in a third direction intersecting the first and second directions and a sixth release position in which the sixth displacement portion releases the pressing,
wherein the first fixed member includes a receiving portion that projects further in the second direction than the first surface or the third surface, and
the sixth displacement portion swings along the first direction between the sixth press position and the sixth release position and includes a pressing portion that, in the sixth press position, presses the receiving portion.

12. The mold device according to claim 11 further comprising
a hinge member that is disposed in a different position from the first fixed member, the hinge member including a shaft member and supporting the first and second molds so as to be rotatable about the shaft member.

13. The mold device according to claim 11 further comprising:
a second fixed member that is fixed to the third surface; and
a seventh displacement portion that is provided on the first surface and rotatably supported by a seventh shaft extending in the second direction, and is displaced in the first direction between a seventh press position in which the seventh displacement portion presses the second fixed member in the third direction intersecting the first and second directions and a seventh release position in which the seventh displacement portion releases the pressing.

14. The mold device according to claim 13 further comprising
a linking portion that links the sixth displacement portion and the seventh displacement portion,
wherein, when the sixth displacement portion is displaced from the sixth release position toward the sixth press position or the seventh displacement portion is displaced from the seventh release position toward the seventh press position, the seventh displacement portion is displaced to the seventh press position before the sixth displacement portion is positioned in the sixth press position.

15. A foam production method comprising:
introducing a foam raw material into the cavity of the mold device for foam molding according to claim 1;
setting the displacement portion in the press position; and
molding a foam by foaming and hardening the foam raw material inside the cavity.
